(19) United States
(12) Patent Application Publication
(10) Pub. No.: US 2022/0229883 A1
(43) Pub. Date: Jul. 21, 2022

(54) SYSTEM AND METHOD FOR PROTECTING, MANAGING AND MONETIZING CREATIVE WORKS USING BLOCKCHAIN

(71) Applicant: UREEQA INC., Kitchener (CA)

(72) Inventors: Harsch KHANDELWAL, Kitchener (CA); Thomas HUNTER, Kitchener (CA); Matt DE JONG, Kitchener (CA)

(21) Appl. No.: 17/578,921

(22) Filed: Jan. 19, 2022

Related U.S. Application Data
(60) Provisional application No. 63/139,092, filed on Jan. 19, 2021.
(60) Provisional application No. 63/250,303, filed on Sep. 30, 2021.

(51) Int. Cl. G06F 21/10; G06Q 30/02; G06Q 30/00

(52) U.S. Cl. CPC G06F 21/10; G06Q 2220/00; G06Q 30/018; G06Q 30/0206

(57) ABSTRACT

A system and method for protecting, managing and monetizing creative works using blockchain including storing the creative works on a blockchain to timestamp the creative work and then validating the creative work. The validated creative work is then minted as a validated NFT which can then be monetized.

### CROSS-REFERENCE TO OTHER APPLICATIONS

The current disclosure claims the benefit of priority from U.S. Provisional Application No. 63/139,092 filed Jan. 19, 2021 and US Provisional Application No. 63/250,303 filed Sep. 30, 2021 both of which are hereby incorporated by reference.

### FIELD

The present disclosure relates generally to a system and method for intellectual property protection, and more specifically, to a system and method for protecting, managing and monetizing creative works using blockchain.

### BACKGROUND

In a digital age, there are more and more varieties of creative works being created and, subsequently, copied by others. Unfortunately, the protection, management and monetizing of these creative works can be complicated, time consuming and difficult. In particular, creative works may include, but are not limited to trademarks, industrial designs, patents, music, videos, e-books, manuscripts, photographs, digital art, software code, websites, inventions, trademarks, designs, copyrights and the like.

Intellectual property, such as copyrights, are generally registered on a national basis, with each registry having their own rules and costs, however, copyright registration for protecting creative works can be slow, ineffective and expensive. Copyright protection typically provides, to the creator or an assignee, an exclusive legal right to print, publish, perform, film, or record literary, artistic, or musical material, and to authorize others to do the same. The copyright is associated with an intangible legal intellectual property right associated with the author of the tangible copyright creation. Copyright ownership is enforced through the legal system providing a foundation to enforce any financial benefit associated with the copyright.

Along with this slow process, copyright registration organizations typically do not perform any validation steps (with respect to copyright protection) to attempt to determine whether the creative work submitted is unique or was previously registered.

While some have attempted to apply blockchain concepts to copyright registration, they use the blockchain concepts to store the registrations.

Therefore, there is provided a novel method and system for protecting, managing and monetizing creative works using blockchain.

### SUMMARY

The present disclosure is directed at a system and method for protecting, managing and monetizing creative works using blockchain. The system may include a set of creative works management components that cooperate with each other to provide the method for protecting, managing and monetizing creative works using blockchain.

In one aspect, there is provided a system and method for the decentralized validation of intellectual property. In another aspect, there is provided a system and method for the decentralized protection of intellectual property (unauthorized use monitoring/detection).

In other embodiments, once a submission (including the creative work) is received by the system, the submission is timestamped by the system. The system can attempt to confirm, or validate, the authorship, ownership and originality of the creative work. If the creative work is validated, the system may provide an output of this validation in different manners. First, a Package of Proof™ is provided which publicly discloses the steps taken to verify the authenticity and originality of the creative work (or submission). Second, a unique non-fungible token (NFT) can be minted (e.g. ERC-721) to represent the creative work. This NFT can then be stored in the blockchain and placed in a marketplace where it can be monetized. By allowing the creator of the work to store their creations or creative works, choose which creations to stake blockchain claims on, determine which creations to protect further by validation and which to monetize, the system is may provide a safe place to protect, manage and monetize a creative work.

In some embodiments, the system may work with clients who manage a portfolio of creative works. For example, a company may opt to protect a character in an animated film that they may re-use. After validation, the NFT for that creative work could be sold through a securitized token offering and the purchasers can be paid in their respective wallets whenever that character is used in films.

In an aspect of the disclosure, there is provided a system for creative works management including a decentralized validation of intellectual property (IP) component; a decentralized timestamping of intellectual property component; an enforceable and divisible tokenization of intellectual property component; an encapsulating trust mechanisms into non-fungible tokens (NFTs) component; and a monetization component.

In another aspect, the decentralized validation of intellectual property (IP) component includes a validation determination component and a package of proof component. In a further aspect, the decentralized validation of IP component further includes a protection program component. In yet another aspect, the decentralized timestamping of intellectual property component includes a batch timestamping component; an individual stake claims component; and a stake claims hash verifier component. In an aspect, the enforceable and divisible tokenization of intellectual property component includes a tokenization of IP component. In another aspect, the encapsulating trust mechanisms into NFTs component includes a validated NFT component; a NFT authenticity checker component; and a NFT redemption centre component.

In another aspect, the monetization component includes a NFT marketplace component; and a set of monetization pathways components. In a further aspect, the set of monetization pathways components include at least one of a tradeable NFT rewards program component; an IP collateralization component; a licensing component; a fractional ownership component; a music publishing component; a transfer of ownership component; and a tokenized insurance component.

In another aspect of the disclosure, there is provided a method of creative works management including receiving a submission, the submission including a creative work and supporting information associated with creation of the creative work, from a user; storing the submission on a blockchain and timestamping the submission; validating if the creative work associated with the submission is original; and generating a package of proof if submission is validated.

In another aspect, the method further includes minting a validated non-fungible token (NFT), the validated NFT including at least the creative work and the package of proof. In yet another aspect, the method further includes minting a child NFT associated with the validated NFT. In another aspect, the method further includes minting a collectible NFT associated with the validated NFT. In yet a further aspect, the method further incudes monetizing the validated NFT or the collectible NFT via a monetization process. In another aspect, monetizing the validated NFT includes at least one of monetizing via a tradeable NFT rewards program component; monetizing via an IP collaterization component; monetizing via a licensing component; monetizing via a fractional ownership component; monetizing via a music publishing component; monetizing via a transfer of ownership component; or monetizing via a tokenized insurance component.

### DESCRIPTION OF DRAWINGS

Other aspects and features of the present disclosure will become apparent to those ordinarily skilled in the art upon review of the following description of specific embodiments in conjunction with the accompanying figures.

Embodiments of the present disclosure will now be described, by way of example only, with reference to the attached Figures.

FIG. 1 illustrates an embodiment of the system herein and an environment for the system;

FIG. 2a is a flowchart of a method of decentralized validation of intellectual property;

FIG. 2b is a flowchart of another method of decentralized validation of intellectual property;

FIGS. 3a to 3c are diagrams of a method of evidence verification;

FIG. 4 is a schematic diagram of a system for automatically searching external databases of creative works;

FIG. 5 is a schematic diagram of a system for automatically accessing external programs or systems for checking existence of creative works;

FIG. 6 is a flowchart outlining a method of ownership verification of smart contracts;

FIG. 7 is a flowchart outlining a method of ownership verification of websites;

FIG. 8 is a schematic diagram of a method of token handling for a creation/validation process;

FIG. 9 is a schematic diagram of a method of payment for timestamping;

FIG. 10 is a flowchart outlining a method of decentralized protection of intellectual property;

FIG. 11 is a flowchart directed at another embodiment of validation of intellectual property; and

FIGS. 12a to 12d are schematic diagrams of another embodiment of a system for protecting, managing and monetizing creative works.

### DETAILED DESCRIPTION

The disclosure is directed at a system and method for protecting, managing and/or monetizing creative works. Examples of creative works include, but are not limited to, trademarks, industrial designs, patents, music, videos, e-books, manuscripts, photographs, digital art, software code, websites, inventions, trademarks, copyrights, designs, different digital files types (mp3, mp4, epub, txt, jpeg, pdf, html) and the like. Embodiments of the disclosure provide a system and/or method that allows for at least one of (i) verification of authorship/ownership of a creative work; (ii) uniqueness of a creative work; (iii) providing a repository of information related to the verification of authorship/ownership of a creative work; (iv) enabling the creative work to be monetized; (v) monitoring for unauthorized use of the creative work; (vi) timestamping of creative works stored on the blockchain and/or (vii) enforcement of a creator's rights. In one embodiment, the distributed nature of blockchain provides advantages over current systems.

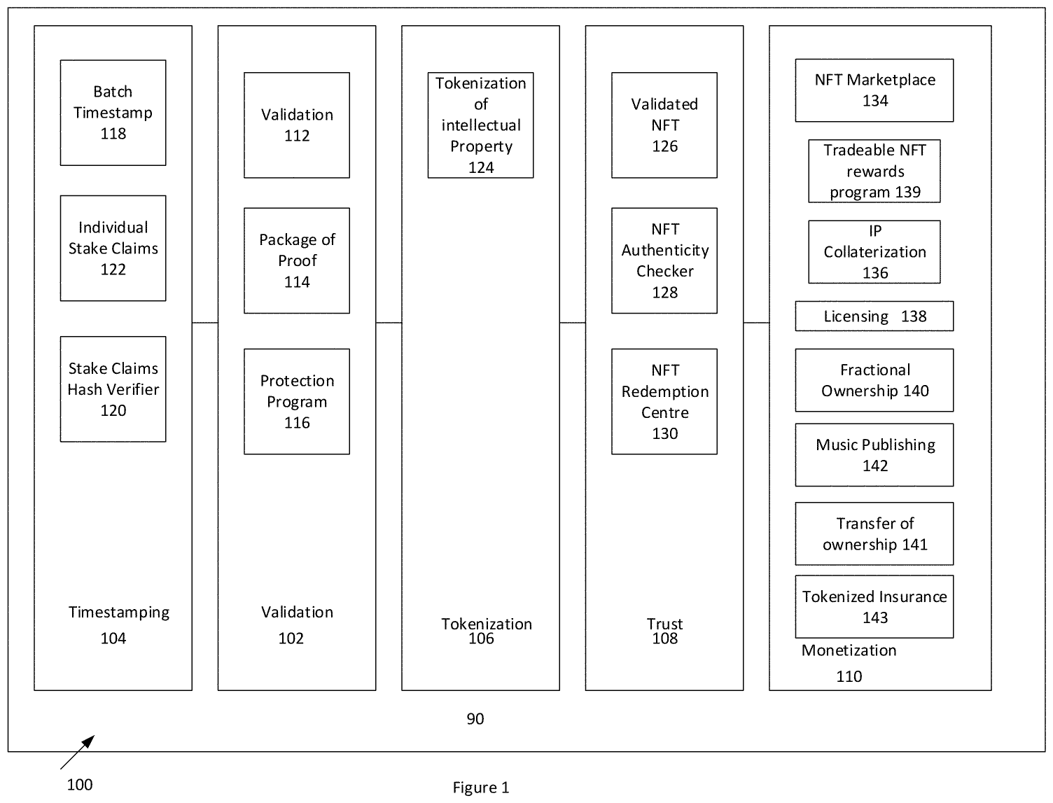

Turning to FIG. 1, a schematic diagram of a system for protecting, managing and/or monetizing creative works is shown. In one embodiment, the system 100 provides a process and functionality for creators to apply various levels of protection to their creative work, tools to verify the protection of that creative work, processes to provide ongoing monitoring of their creative work, and processes to monetize their creative work using a combination of traditional and blockchain technology. The system 100 may be stored or implemented via a server 90 (such as a web server) that may be in communication with a file server, a database and a blockchain. The system 100 includes at least one processor for executing a program or programs that implement the functionality described herein. In operation, a creator or user interacts with the system from a user computing device, such as, but not limited to, a computer or a smart device.

In the current embodiment, the system 100 includes a decentralized validation of intellectual property (IP), or validation, component 102; a decentralized timestamping of intellectual property, or timestamping, component 104; an enforceable and divisible tokenization of intellectual property, or tokenization, component 106; an encapsulating trust mechanisms into non-fungible tokens (NFTs), or trust, component 108; and a monetization component 110.

With respect to the timestamping component 104, the timestamping component 104 enables creators to post a permanent record (with a timestamp) of their creative work to the blockchain, in a short period of time, such as in minutes. The timestamping component 104 records the claim, or submission, of the creative work as a public, immutable record on a blockchain that the creator can use to prove the creative work is theirs. In one embodiment, the decentralized timestamping of intellectual property component 104 allow claims of ownership to be made quickly and inexpensively by creating, for example, a one-way hash of a submitted creative work on a blockchain (for example, a public blockchain such as Ethereum). This may be seen as a process of decentralized timestamping of intellectual property.

Once a claim of ownership is made, the blockchain will store immutable proof to secure the timestamp of submission. In the current embodiment, the decentralized timestamping of intellectual property component 104 includes a batch timestamp component 118, a stake claim hash verifier component 120 and an individual stake claims component 122. The batch timestamp component 118 and the individual stake claims component 122 may be seen as two modules, executing on the processor that is in communication with a blockchain, that may be able to perform the timestamping of intellectual property on, or to, the blockchain. In one embodiment, the decentralized timestamping of intellectual property component may enable creative works to be created as a record on the blockchain in a batch manner (via batch timestamp component 118) or individually (via individual stakes claim component 122). For the stake claim hash verifier component 120, a hashing function is used to verify the timestamps created from the batch timestamp 118 and/or individual stake claim 122 components. In a particular embodiment, only the hashed file or a zip file (which contains the creative work and other information) provided by the user will be able to generate the stored hash on the blockchain entry. This enables users to prove the claim/timestamp on the blockchain, including the date and time, the name of the user who created the timestamp, and other information. The timestamping component 104 may be seen as the first level of protection that a creator, or user, can use to protect their creative work.

With respect to validation component 102, the validation component 102 may be seen as a next level of protection after the timestamping component 104. The decentralized validation of intellectual property component 102 may include a validation determination component 112, a package of proof component 114 and a protection program component 116 (which may also be seen as a decentralized protection of intellectual property component). The validation determination component 112 may provide the functionality to allow creators of a creative work to increase protection of their creative work by validating the provenance of the creative work. Component 112 provides the functionality to validate the authorship, ownership, and originality, among other things, of an artist's creative work, such as in the form of a validation process. In one embodiment, the validation process may include interaction of the system, executing on the processor, with a team of global validators who work together in a gig-like fashion. In one embodiment, during the validation process, the decentralized network of certified validators may provide input to the system to validate the creative work based on validation criteria, such as, but not limited to, the point in time that the creative work was originated; the authorship and ownership of the creative work; and/or the uniqueness of the creative work. In one embodiment of the validation process, in a gig-like fashion, validators, that may be located globally, will be notified of an electronic creative work submission and the first certified validator(s) to accept the notification get the work. The results generated, or determined, by the validation determination component 112 may then be summarized in a Package of Proof (which may be generated by the package of proof component 114) that documents all steps taken to prove the authenticity of the creative work which may then be stored on the blockchain. The Package of Proof is a permanent, public record stored on the blockchain that the creator can use to prove the work is theirs.

The protection program component 116 may provide the functionality of decentralized protection of intellectual property. In one embodiment, the protection program component interacts with a set of protectors who search the internet and databases for unauthorized and/or unreported use of a creator's creative work and reports any such uses to the creator.

With respect to the protection program component 116, as part of component 102, the system may engage with a network of protectors, where the protectors may be located globally, to scour the digital and physical world for unauthorized and/or unreported use of protected creations. The network of protectors may then interact with the protection program component to assist the system in protecting the creative work from unauthorized use.

In one embodiment of use, the network of protectors may use internal and/or 3^{rd} party technology and databases to identify unreported and/or unauthorized use which is then input to the system via the protection program component 116. In one embodiment, this unauthorized use may be reported and action taken by the system such as, but not limited to, sending out demand letters with links to remedy via payment of a specified amount. In some cases, protectors may be engaged to perform routine monthly checks for unauthorized use. In other cases, the regular monitoring of unauthorized and/or unreported use of IP on platforms like ISPs, using component 116, can be seen as part of a due diligence process that ISPs may employ as part of their response to regulation and lawsuits dealing with copyright infringement on their platforms

With respect to the tokenization component 106, once a piece of creative work is validated through the validation component 102, the tokenization component 106 enables the tokenization of the creative work through non-fungible tokens (NFTs). In one embodiment, anyone can mint an NFT, whether they own the creative work or not. The system 100 and tokenization component 106 provides processes to mint NFTs that have been authenticated, or validated, by validation determination component 112, to generate validated NFTs. Only a creative work that has undergone validation, such as via validation determination component 112, will be minted as a validated NFT. Validated NFTs will include a reference to the Package of Proof generated by the package of proof component 114 and other important information to improve trust and transparency in NFTs. In the current embodiment, the tokenization component 106 includes an enforceable tokenization of intellectual property component 124. The tokenization component 106 leverages the strengths of blockchain technology while integrating and respecting the legal contracts required to make the ownership and transfer of NFTs enforceable. In some cases, validated NFTs will include relevant legal documents in the NFTs blockchain record, by way of hashing functions, to enable the transfer of NFTs in a manner that makes the transfer enforceable by the legal system. Tokenization of intellectual property component 124 also enables creators to mint child NFT(s) that are tied to the validated NFT. Child NFTs may also incorporate legal contracts, through hashing functions, to provide rights to the owners of the Child NFTs. In some cases, Child NFTs provide opportunities for monetization of the creative work, such as, for example, licensing, syndication, or the like.

With respect to the encapsulating trust, or trust component 108, the trust component 108 encapsulates trust with respect to the validated, or child, NFT. In one embodiment, the trust component 108 includes a validated NFT component 126, a NFT authenticity checker component 128, and a NFT redemption centre component 130. The encapsulation of trust component may provide trust and transparency to owners, buyers and sellers of NFTs. The encapsulation component 108 may provide the functionality to mint a validated NFT and to then, if desired, mint a collectible NFT associated with the validated NFT. These collectible and validated NFTs may be authenticated by the encapsulation component so that purchasers of these NFTs may have confirmation that they are purchasing an authentic NFT. The NFT authenticity check components 128 and the NFT redemption centre component 130 may be seen as tools that an owner, buyer or seller of NFTs can use to confirm the authenticity of the NFT and confirm information regarding the status of utilities associated with the NFT.

With respect to the monetization component 110, while components 104 (timestamping), 102 (validation), 106 (tokenization), and 108 (encapsulating trust) provide the user with the functionality or processes to protect and tokenize their creative work, the monetization component 110 provides a process for creators to monetize their creative work. In the current embodiment, the monetization component 110 includes a NFT marketplace component 134, an IP Collateralization component 136, a licensing component 138, a fractional ownership component 140, a tokenized tradeable rewards component 139, a transfer of ownership component 141, a tokenized intellectual property insurance component 143 and a music publishing admin (MPA) component 142. The monetization component may provide the functionality for a creator who owns validated creative work, a validated NFT and/or child NFT to monetize their creative work. These monetization processes are enabled by component 110 via its integration with components 104, 102, 106 and 108. The monetization component 110 may provide a plurality of different options for a creator to select and then guides the creator through the process to monetize the creative work in the selected manner. For example, by utilizing results generated by the validation component 102 and tokenization component 106, this may provide important information about the NFT and the associated creative work to an individual or corporation to collateralize the NFT or underwrite insurance on the NFT (using tokenized intellectual property insurance component 143). In another example, utilizing validation component 102, tokenization component 106, and trust component 108, a NFT marketplace (component 134) may provide more trust and transparency to NFT transactions.

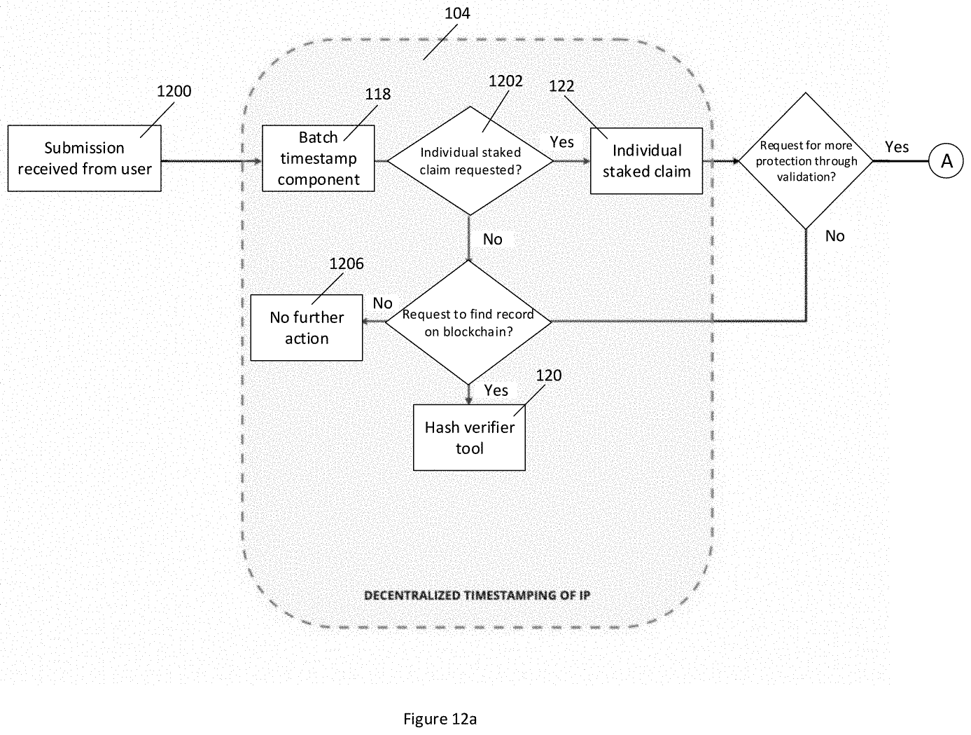

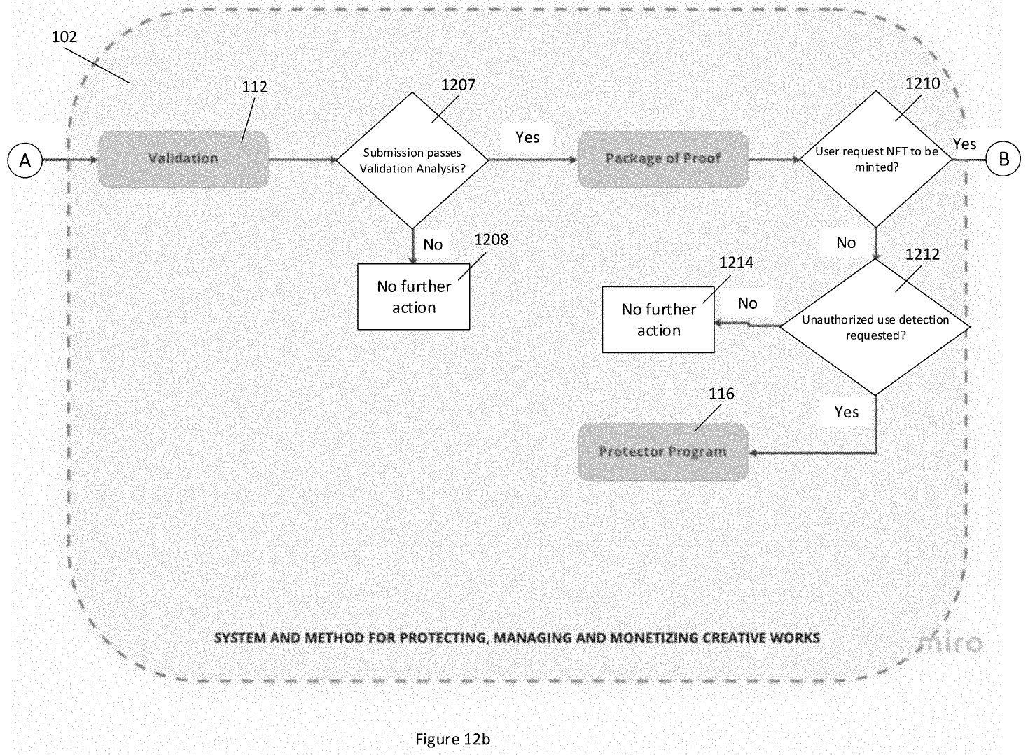

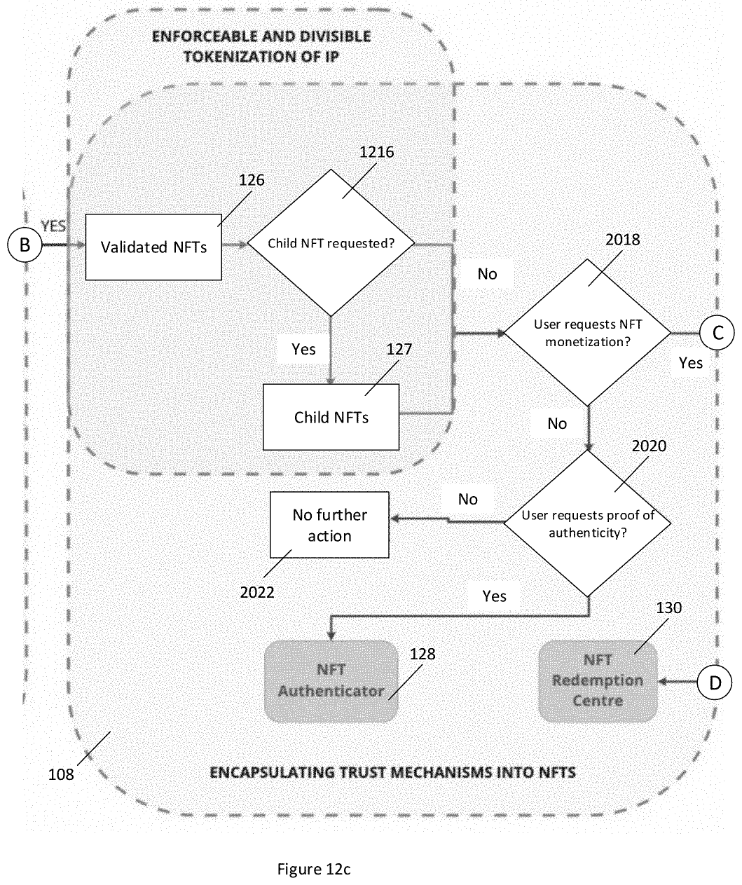

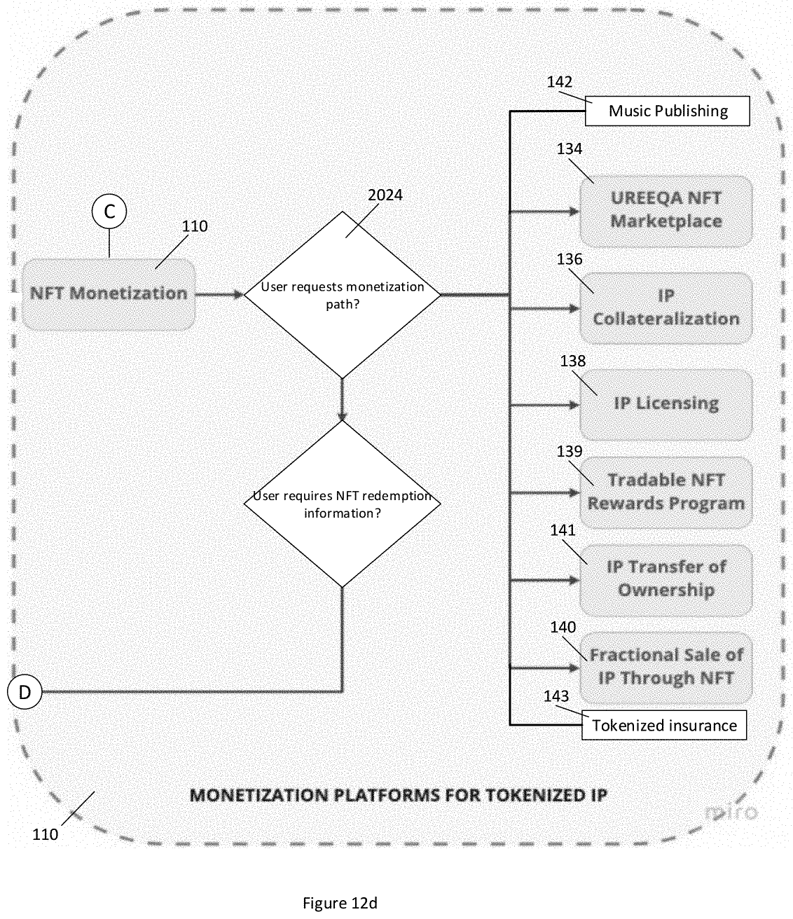

FIGS. 12a through 12d provide a flow chart of one embodiment of the system 100. As shown in FIG. 12a, an electronic submission is received from a user or creator who is seeking protection of and/or trying to monetize their intellectual property (1200). The submission is received by the decentralized timestamping component 104 (via the batch timestamp component 118). The timestamping component 104 then determines if the submission includes a request for more protection through an individual staked claim 1202). If so, the submission is passed to the individual staked claim component 122. If there is no request for more protection through individual staked claim (1202), the user can request to find their timestamp on the blockchain using the hash verifier tool 120. If the user does not wish to use the hash verifier tool 120, the system takes no further action (1206).

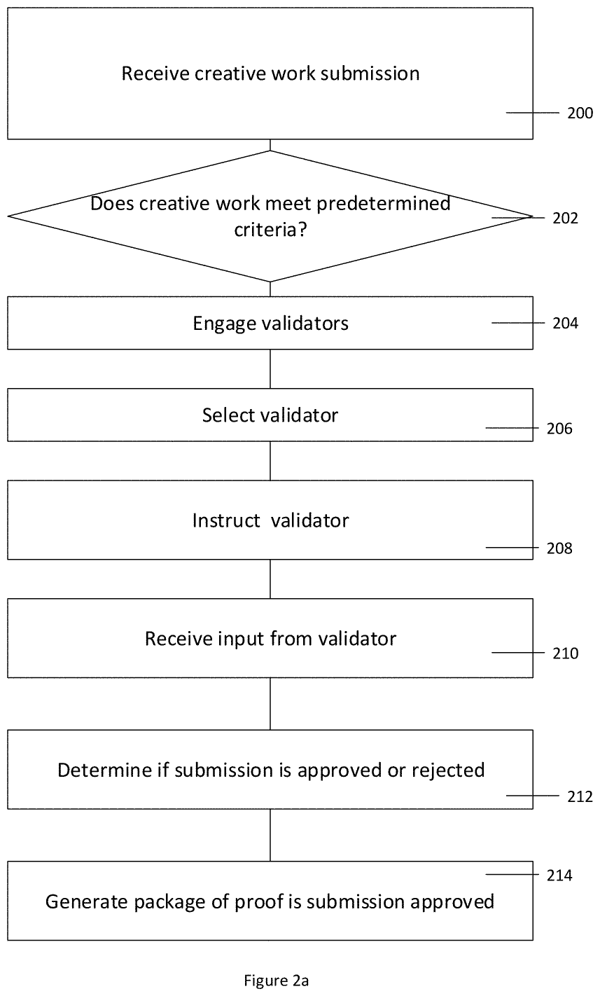

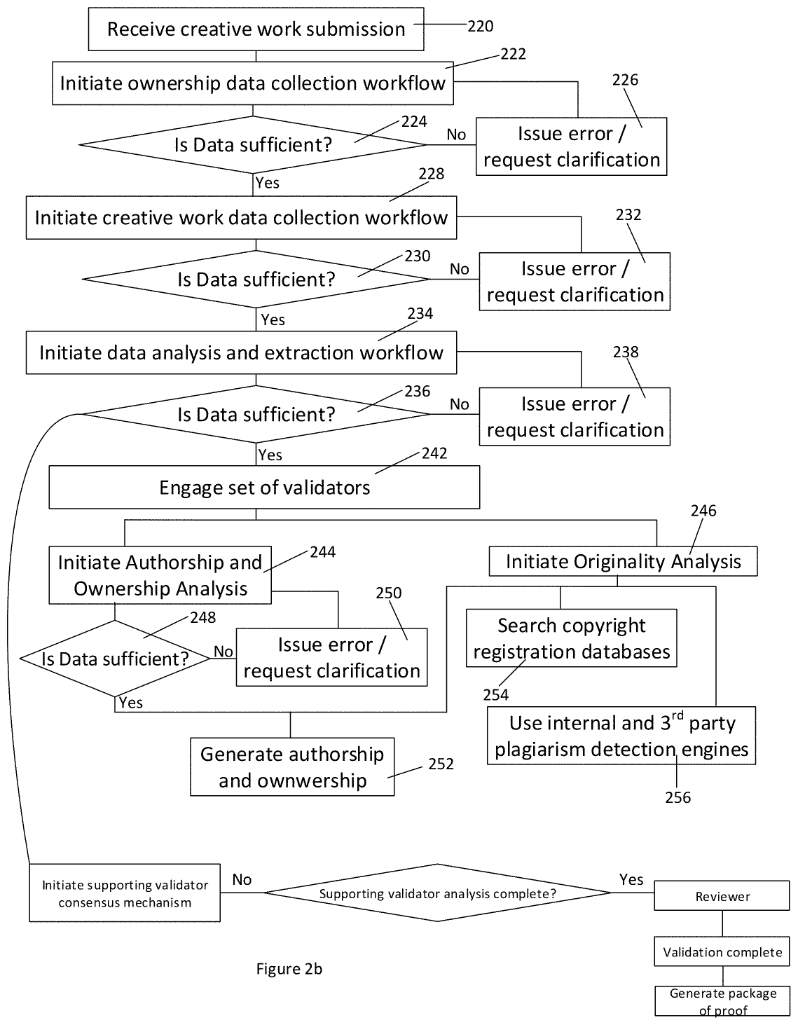

If the submission is passed to the individual staked claim component, the system determines if the user is requesting more protection for their creative work through a validation of the creative work. If there is no request for protection through validation, the user can request to find their timestamp on the blockchain using the hash verifier tool 120. If the user does not wish to use the hash verifier tool 120, the system takes no further action (1206). If the creator or user is requesting more protection through validation, the submission is passed to the validation of intellectual property component 102 (as shown in FIG. 12b). The submission is then reviewed/validated by the validation component 112. Different methods of validation are discussed with respect to FIG. 2a, 2b or 11. The system then determines if the submission or creative work passes the validation analysis (1207). If not, no further action is taken (1208). If so, a package of proof is generated by the system.

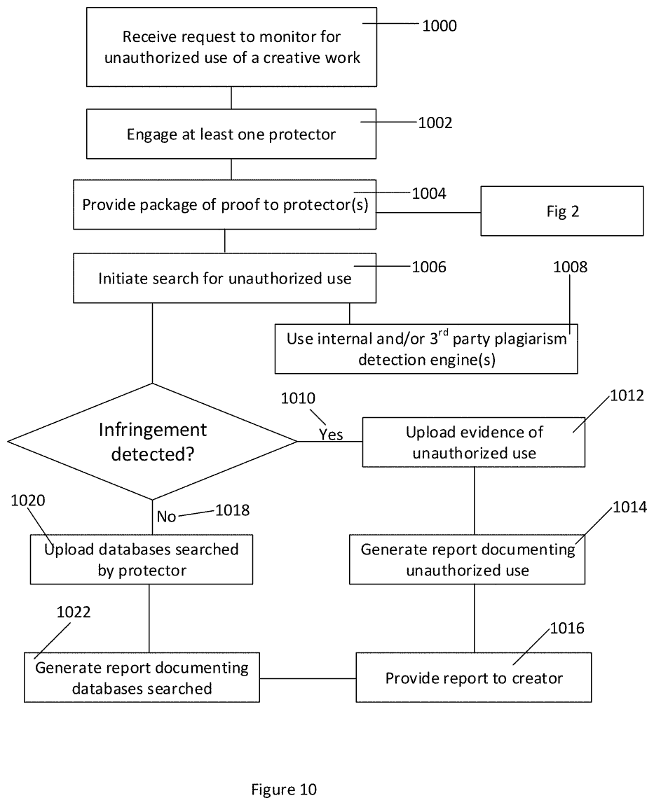

The system then determines if the user has requested an NFT to be minted as a result of the validated submission (1210). If no minting is required, the system determines if the user has requested unauthorized use detection or monitoring (1212). If not, no further action is taken (1214). If unauthorized use detection or monitoring is requested, the system passes the submission to the protector program component 116. In one embodiment, the protector program component may perform unauthorized use monitoring such as taught with respect to FIG. 10.

If the user requests an NFT to be minted, the system passes the submission to the validated NFTs component 126 of the encapsulating trust mechanisms component 108 for minting of the validated NFT. In some embodiments, each time a creative work is validated, an NFT may be minted for that creative work. This validated NFT may be seen as a creator's immutable claim to the creation and registered on a blockchain. The NFT may be associated, or include, the creator's package of proof, stored on the blockchain, for example as a hash of one or more files or the like. This combination of the profile pages, packages of proof, and NFTs allows the creator to manage the creative content/work.

The system then determines if the user has requested that a child NFT has been requested (1216). If a child NFT has been requested, the system transmits the submission to a child NFTs component 127 for the creation of a child NFT.

If no child NFT has been requested, or after generation of the child NFT, the system determines if the user has requested monetization of the NFTs (2018). If not, the system determines if the user has requested a proof of authenticity of the NFT (2020). If there is no request for this proof, the system takes no further action (2022). If the user has requested a proof of authenticity of the NFT, the system passes the submission to the NFT authenticator component 128.

If the user has requested monetization of the NFT, the system passes the submission from the encapsulating trust mechanisms component 108 to the monetization component 110. For example, the NFT may be monetized by selling or transferring ownership of the NFT; licensing the NFT; completing a legally compliant securitized token offering (STO) for the NFT whereby the creator can sell all or part of their work, and the like. Other methods of monetization are contemplated. In some examples, each NFT can also be visually represented as a QR code and validation number. This symbol can be published by the creator as a seal of validation, which can be scanned to take the user to the profile page or the like. This provides creators another avenue to drive monetization of their content.

The system then determines which monetization path the user has requested or selected (2024). This may be included as part of the electronic submission or the system may prompt the user for a selection. Based on the input from the creator, the system then connects the user with the NFT marketplace component 134; the IP collateralization component 136; the IP licensing component 138; a tradable NFT rewards program 139; a transfer of ownership component 141, the tokenized insurance component 143, the music publishing component 142 or the fractional ownership component 140. If the user requires NFT redemption information and/or functionality, the system may provide this information via the NFT redemption component 130.

FIG. 12a through 12d provides one embodiment of the system 100. In other embodiments, each component, or subcomponent of, 102, 104, 106, 108 and 110 can be used independently.

Turning to FIG. 2a, a flowchart showing one embodiment of a method of validating a creative work, component 112, is shown. Initially, the system receives an electronic creative work submission (200) from an individual or a creator of a creative work. The system may then analyze various aspects of the creative work to determine, among other things, if the individual is the true author and/or owner of the creative work being submitted, and if the work is original.

The system then determines if the submission meets a set of predetermined criteria (202). This determination may include determining if there is sufficient data, or information, in the submission to initiate the validation process. If it is determined that the submission meets the predetermined criteria, the system then engages with a set of validators to validate the submission (204). In one embodiment, the system may retrieve contact information associated with a set of validators and then transmit a message to the validators informing them that a new submission has been received. In another embodiment, the system may transmit a message to a single validator from the set of validators with instructions to perform a validation on the submission.

The system then selects at least one validator to perform the validation of the creative work submission (206). The system may then instruct the selected validator(s) to perform the validation (208). In one embodiment, the validator(s) may be instructed by the system to initiate an authorship and/or ownership analysis of the creative work that was submitted. In another embodiment, the validator may be instructed by the system to perform an originality analysis. In other embodiments, the validator may be instructed to perform both the authorship and/or ownership analysis and the originality analysis. Alternatively, different validators may perform each of the analyses.

The system then waits to receive the results of the analysis (210) from the validators. Based on the input from the validator(s), the system may then determine if the submission is approved or rejected (212). If the submission is approved, the system may generate a package of proof for the submission (214).

Turning to FIG. 2b, a flowchart of a more specific embodiment of a method of validating a creative work submission is shown. In the current embodiment of FIG. 2b, the method may be seen as one or more data collection workflows/processes/modules configured to guide, or automate, the submission process for the user or individual. The method assists the user to submit required information such as, but not limited to, the type of creation, their residency at the time of creation and/or the authorship type via a data collection workflow. In one embodiment, the information necessary to verify authorship, ownership and originality may be collected (and stored) but any other information may be discarded, depending on privacy laws or the like. The data collection components may be configured to automatically detect conflicting information and prompt the user for modified or additional information.

Initially, the system receives a submission from an individual (220). After receiving the submission, the system may initiate an authorship and ownership data collection workflow (222). To determine if the authorship and ownership data collection workflow should be initiated, the system determines if there is enough data, or information, in the submission (224). If there is insufficient data, the system issues an insufficient data error and/or clarification request to the user (226) and then checks again if the authorship and ownership data collection workflow should be initiated (222).

If the data is determined to be sufficient, the system may then initiate a creative work data collection workflow (228). To determine if the creative work data collection workflow should be initiated, the system determines if there is enough data, or information, in the submission (230). If there is insufficient data, the system issues an insufficient data error and/or clarification request to the user (232) and then checks again if the creative work data collection workflow should be initiated (228).

If the data is determined to be sufficient, the system may then initiate a data extraction and analysis workflow (234). To determine if the data extraction and analysis workflow should be initiated, the system determines if there is enough data, or information, in the submission (236). If there is insufficient data, the system issues an insufficient data error and/or clarification request to the user (238) and then checks again if the data extraction and analysis workflow should be initiated (234).

If the data is determined to be sufficient, the system then engages a set of validators (242) and selects at least one validator to perform validation of the submission. Once selected, the system provides the validator(s) with the information that has been received or collected by the system with respect to the submission.

In the current embodiment, at least one validator may initiate, or may request the system to initiate, an authorship and ownership analysis process or module (244) or may initiate an originality analysis process or module (246). A different validator may perform each analysis or the same validator may perform both analyses.

In one embodiment, the authorship & ownership analysis process or module (seen as a process) may include a review and compilation of data extracted from the files, such as metadata, or information, submitted or provided by the creator. The authorship & ownership analysis process may be configured to utilize the information provided by the creator (an individual submitting the submission) to assess the authorship and ownership of the creation. In one embodiment, the authorship & ownership analysis process provides templates for copyright assignments, work for hire agreements and/or affidavits, depending on the level of protection selected by the submitter. The authorship & ownership analysis process may also be configured to analyze work process documents that are submitted, including, but not limited to, previous drafts of the creative work, images of the creator in the act of creating the work, and correspondence or other files that prove the authorship and ownership of the creative work.

With respect to the originality analysis process, this process may be configured to utilize or may include internal and/or 3rd party tools and databases to verify originality of the creative work and document the process or evidence obtained. This may include at least one plagiarism detection engine such as, but not limited to, software, hardware or firmware tools that may generate or perform reverse images searches (visual art), generate or perform reverse video searches (videos), and research written plagiarism search engines (written work). In one embodiment of the present disclosure, the originality analysis process may analyze databases automatically and without the need for validators.

In other embodiments, the validator(s) use the data and information to assess the authorship, ownership and originality and any other elements related to the validation of the creative work.

When the authorship and ownership analysis is initiated, the validators may determine if there is sufficient data for the validator to perform this analysis (248). If the validator deems there is insufficient data, the system issues an insufficient data error and/or clarification request to the user (250). Once sufficient data and/or clarification is received by the system and validator from the user, the validator continues the authorship and ownership analysis (244). Once the authorship and ownership analysis are complete by the validator(s), the system may generate an authorship and ownership validation (252).

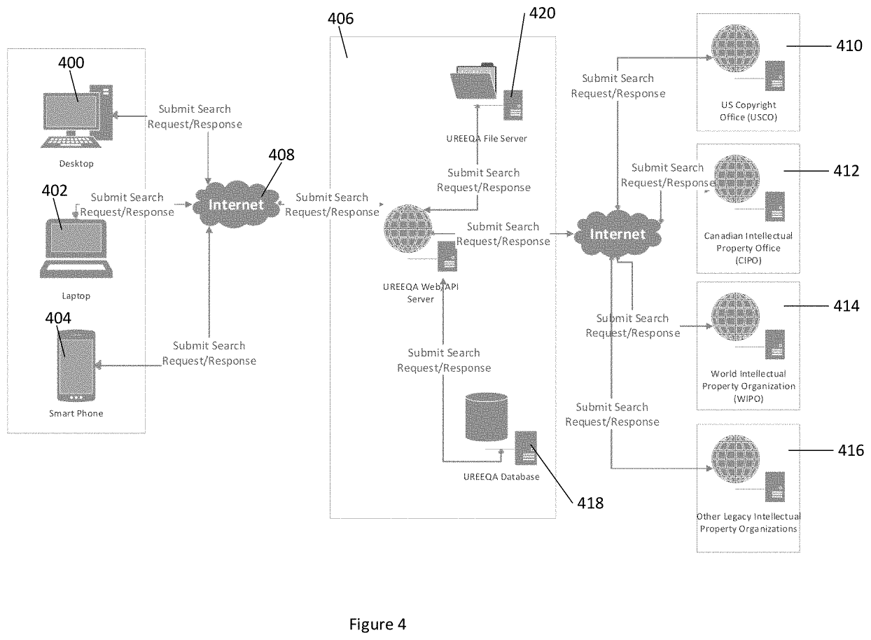

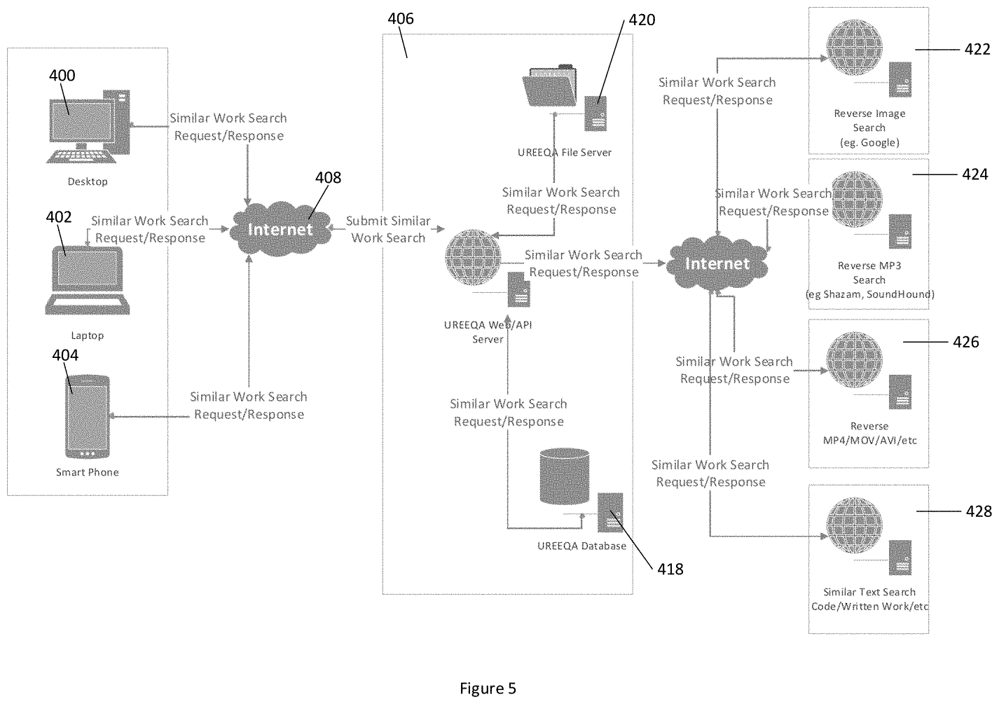

For the originality analysis, the user or system may search or access existing copyright registration agency databases (254) (schematically shown in FIG. 4) or use internal and 3^{rd} party plagiarism detection engines (256) (schematically shown in FIG. 5) to retrieve information with respect to originality. The system may then determine if the creative work associated with the submission is original. If it is, the system issues or generates an originality validation (252).

Once the authorship & ownership analysis and originality analysis process are completed by the set of validators, the set of validators vote as to whether the creation is authentic or not. The set of validators may include a lead validator and a plurality of supporting validators. A reviewer (or the system) may audit the work. Once approved, a package of proof is generated by the system that documents all of the steps taken to validate the work. In one embodiment, the package of proof provides evidence of the protection of the creative work well beyond a simple claim of rights such as might be provided by an intellectual property office and/or a blockchain timestamp. If not, the system generates a non-original determination result.

In one embodiment of FIG. 2b, the disclosure may be seen as a data extraction and analysis process that is configured to generate and analyze authorship and ownership data, for example, from files submitted by the user. If insufficient information is received by the system, the system prompts the user for more information. In another embodiment of FIG. 2b, the disclosure may be seen as an authorship & ownership analysis process that is configured to perform a review and compilation of data extracted. In yet another embodiment of FIG. 2b, the disclosure may be seen as including an originality analysis process/module that is configured to utilize internal and/or 3rd party tools and databases to attempt to verify originality of the creative work and document the process/evidence obtained. In yet a further embodiment of FIG. 2b, the disclosure may generate or create a package of proof that documents and/or evidences of the entire validation process.

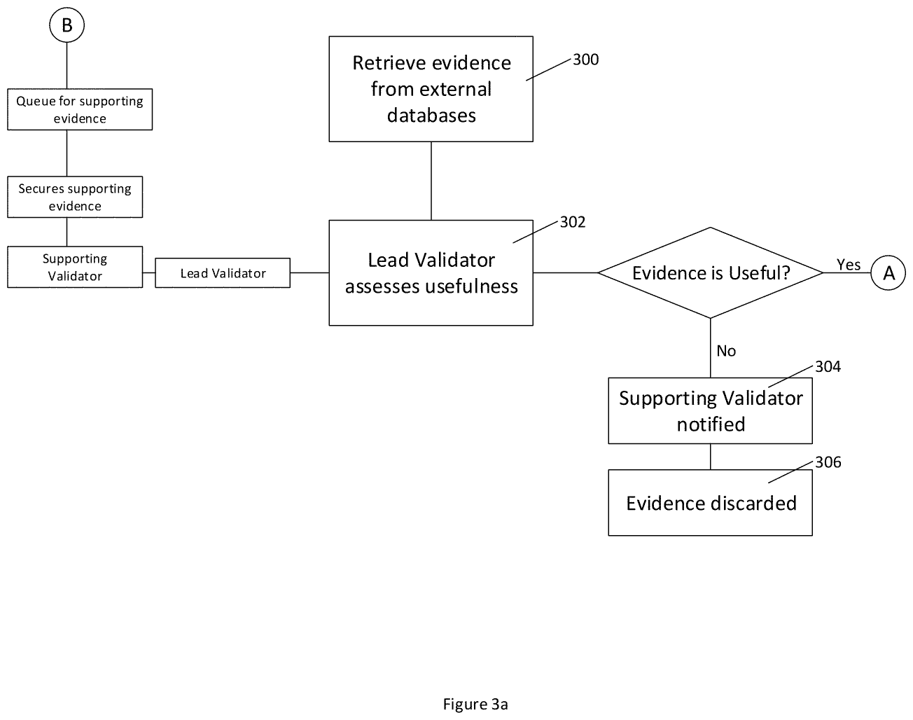

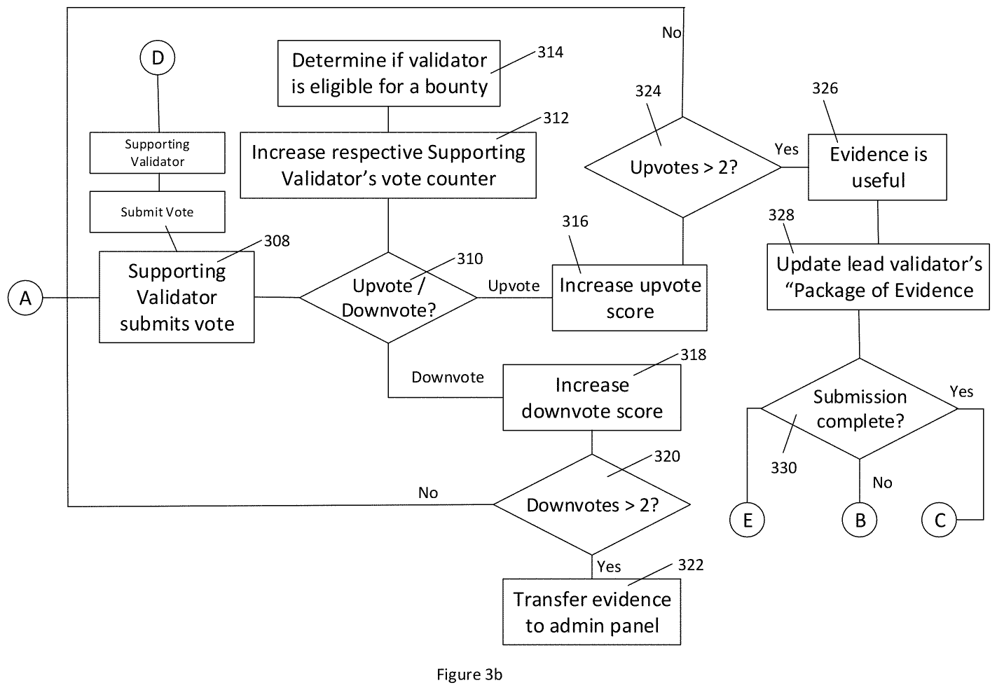

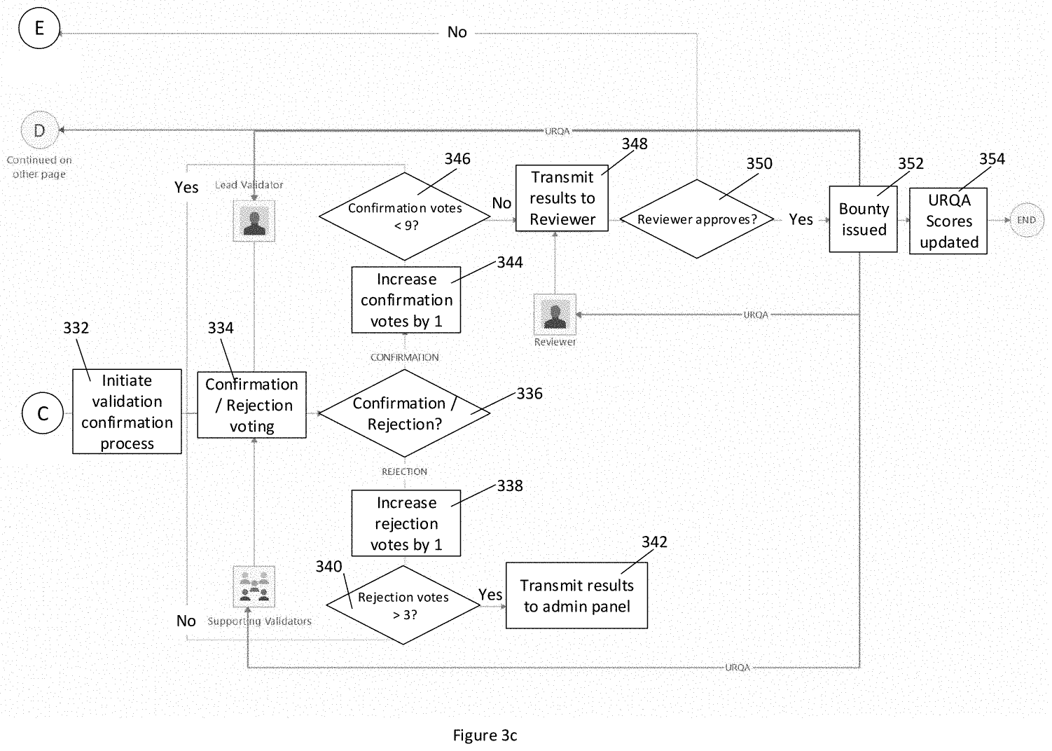

Turning to FIGS. 3a to 3c, a flowchart outlining an embodiment of evidence verification and voting system is shown. In one embodiment, the method of FIGS. 3a to 3c shows processes that may be used for various decision points, or combination thereof, for the methods shown in either FIG. 2a or FIG. 2b. In the current example, two validators, a lead validator and a supporting validator, have been selected although it will be understood that multiple lead or supporting validators may be used.

Initially, the lead validator assesses a usefulness of a piece of evidence included in the submission from the creator or submitter or evidence that the system may retrieve from external databases (300). The lead validator may then determine if the evidence is useful (302). If it is not useful, the supporting validator is notified by the system (304) and the evidence is discarded (306).

If the evidence is useful, the supporting validator may then submit a vote (received by the system) (308) relating to their opinion regarding the usefulness of the evidence. The system may then determine if the supporting validator submitted an upvote or a downvote (310) and updates the system accordingly. The system may then update the system to reflect the work performed by the supporting validator (312) to determine if the supporting validator is eligible for a bounty, or payment (314).

If the supporting validator submitted an upvote, the system increases an upvote score (316) for the evidence and if the supporting validator submitted a downvote, the system increases a downvote score (318) for the evidence. If the system determines that the number of downvotes is greater than a predetermined value (320), such as two, the system transfers the evidence, or result, to an admin panel (322). If the system determines that the number of upvotes is greater than a predetermined value (324), such as two, the system determines that the evidence is useful (326). The system may then update the lead validator's “package of evidence” (328). The system, such as via input from the lead validator, may then determine if the submission is complete (330). If complete, a validation confirmation process is initiated (332). The lead validator and the supporting validator or validators may then input their vote with respect to confirmation or rejection of the submission (334). The system then determines if a confirmation or rejection vote has been received (336) based on the individual votes.

If the system receives a rejection vote, the system updates the rejection votes score by 1 (338). If the number of rejection votes is less than three (340), the system continues to wait for more votes from validators (334). If the number of rejection votes is greater than three (340), the system transmits this result to the admin panel (342). It is understood that the selection of a threshold number is arbitrary and based on requirements by a system designer.

If the system receives a confirmation vote, the system updates the confirmation votes score by 1 (344). If the number of confirmation votes is less than nine (346), the system continues to wait for more votes from validators (334). If the number of confirmation votes is greater than nine (346), the system transmits this result (and the submission) to a review process or reviewer (348). It is understood that the selection of a threshold number is arbitrary and based on requirements by a system designer.

The system may then determine if the reviewer approves the submission (350), and if so, payment to the validators is issued (352). The system may the update characteristics associated with the validators to monitor or keep track of validator performance (354). If the submission is not approved, the system returns to the lead validator with commentary and feedback and the lead validator provides further analysis and evidence gathering (330).

In one specific embodiment of FIGS. 3a to 3c, validations may be performed by a lead validator who manages the evidence verification process. As indicated above, the lead validator may be assisted by, for example, nine supporting validators who assist as required or requested by the lead validator.

In this specific embodiment, at the start of the validation confirmation process (332), the lead validator casts a confirmation vote to mark the validation as complete whereby validation via the voting process may be initiated so that the supporting validators can also cast their vote. As discussed above, the voting process may require nine confirmation votes from supporting validators to mark the evidence validation process as complete or three rejection votes from supporting validators to require the system to transmit the evidence validation process to the admin panel, or priority queue.

Once marked as complete, the validation of the evidence may initiate a review process whereby the evidence validation may be checked by an appointed individual (or reviewer). Once approved by the reviewer (and inputted into the system), the system may issue or distribute bounty tokens to the validator or validators. In some embodiments, validators can attain reviewer status once they have reached a threshold UV rating (discussed later). Over time, reviewers may be able to relieve system staff of the review duties.

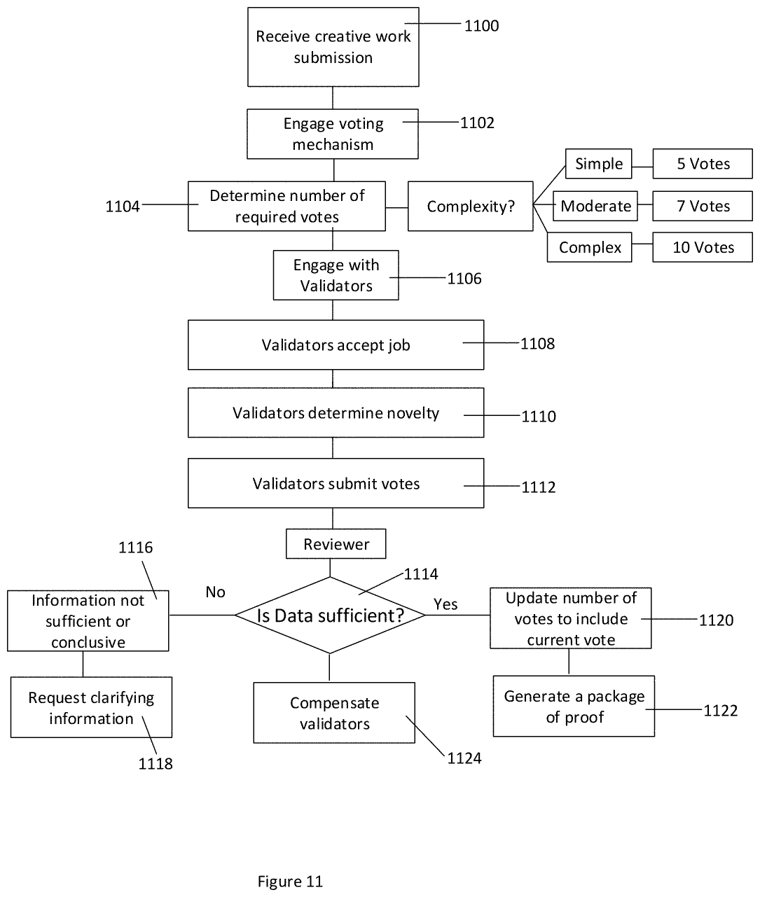

FIG. 11 provides a flowchart outlining another embodiment of decentralized validation of intellectual property that may be executed or performed by the validation determination component 112. The embodiment of FIG. 11 does not include lead and supporting validators but provides a system whereby each validator works on the validation analysis independently. In this embodiment, all of the validators independently submit the results of their analysis of authorship, ownership, originality and other elements of the validation of the creative work. In the spirit of a decentralized validation process, the votes provided by the validators provide a consensus result for the validation of the creative work. The votes and results are reviewed by the reviewer and either approved or sent back to the validators requesting clarification. Once the validation is deemed complete by the reviewer, the system generates a package of proof and issues payments to the participating validators. This is discussed in more detail below.

As with before, the system initiates the process upon receipt of an electronic submission from a creator (1100). After receiving the submission, the system engages a voting mechanism process (1102). The system may then determine a number of votes required for the submission to be validated (1104). This may be based on a complexity of the submission whereby a simple validation may require five votes, a moderate validation may require seven votes and a complex validation may require ten votes.

After determining a number of votes required, the system engages with a set of validators (1106) which may include at least one lead validator and a set of supporting validators. The validators (which may be seen as Validator 1 to Validator “n” where “n” may be any number of validators engaged with the system to accept the job (1108), perform the validation by reviewing the submission to determine if the submission is novel (1110) and then submits their vote with respect to validation to the system (1112) where it is stored by the system.

The system may then provide the information submitted by the validators to a reviewer who then checks the work done by the validators. The reviewer or the system may then determine if there is sufficient data supplied by the validator to support the submitted vote (1114). If it is determined that the information is not sufficient or conclusive (1116), the system transmits a request to the validator to clarify their submission (1118). If it is determined that the information is sufficient and/or conclusive, the system may then update the number of votes received to include the current vote (1120) determine if the submission has passed a predetermined threshold of approval or rejection. If there are not enough votes, the system continues to receive votes from the other set of validators. If approved, the system then generates a package of proof (1122) for the creator to validate their submission. The system may then compensate the validators by transmitting cryptocurrency to the validator's cryptocurrency wallet (1124).

FIGS. 4 and 5 provide example embodiments in which the system accesses external databases or programs to conduct searches in existing databases of intellectual property such as national, regional, or international offices or for plagiarism detection via external third party software and/or system-run plagiarism detection systems. This may be performed manually or automatically.

Turning to FIG. 4, a schematic diagram of components that may be used as part of the originality analysis is shown. FIG. 4 may be seen as a method and system for searching existing registration agency databases.

With respect to FIG. 4, a creator, using a user device such as a desktop 400, a laptop 402 or a smartphone 404 and the like, may access the system 406 via the Internet 408. The system 406 may then access individual intellectual property office databases, such as, but not limited to, the US Intellectual Property Office database 410, the Canadian Intellectual Property Office database 412, the World Intellectual Property Organization database 414 or other Intellectual Property Office databases 416. The system may communicate with the individual databases to determine if the submission provided by the creator is original i.e. it has not been previously filed for protection in any intellectual property office. The results of this determination may be stored within a database 418 associated with the system 406 and communicated to the creator via the user device. The system 416 may also include a file server 420.

With respect to FIG. 5, a creator, using a user device such as a desktop 400, a laptop 402 or a smartphone 404 and the like may access the system 406 via the Internet 408. The system 406 may then access different plagiarism engines or resources such as, but not limited to, tools that may generate or perform reverse images searches (visual art) 422, generate or perform reverse MP3 searches 424 (music), generate or perform reverse video searches 426 (videos), and research written plagiarism search engines 428 (written work). The system may communicate with the individual databases to determine if the submission provided by the creator is original. The results of this determination may be stored within a database 418 associated with the system 406 and communicated to the creator via the user device. The system 416 may also include a file server 420.

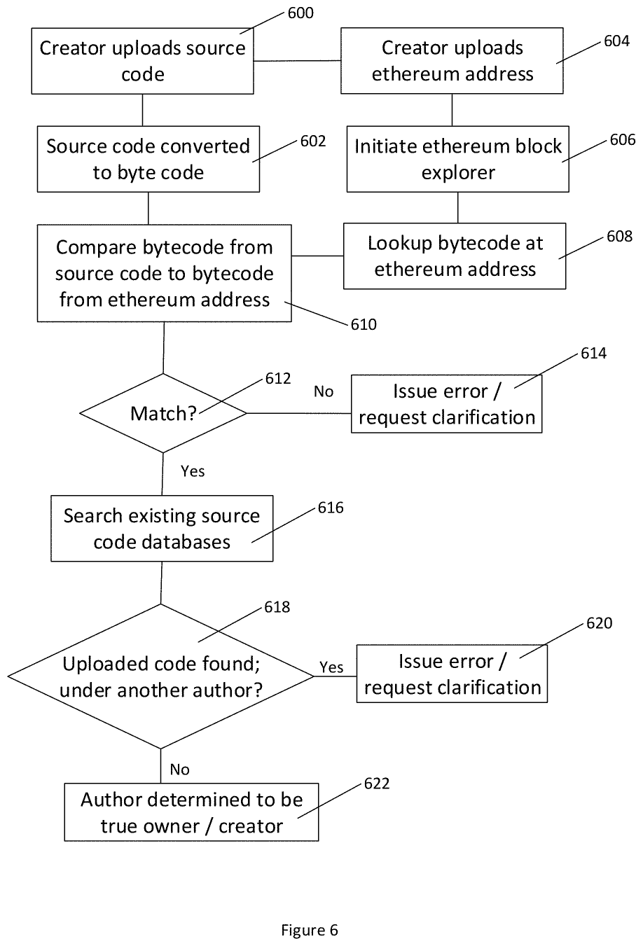

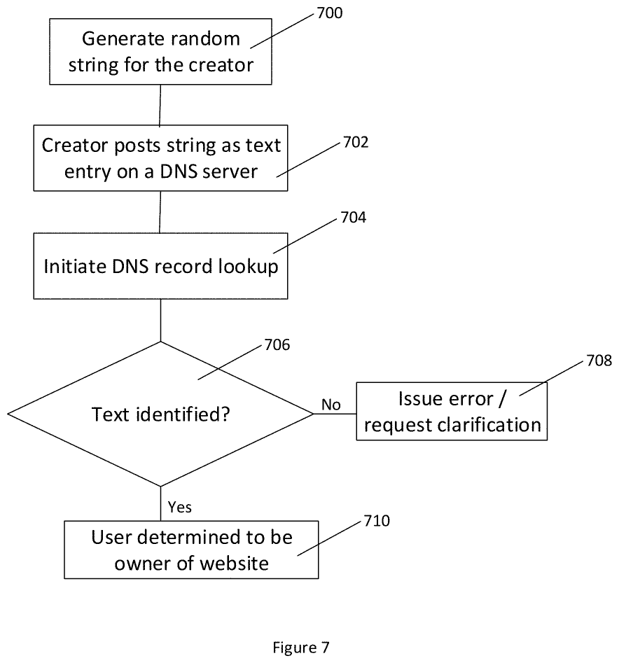

Examples of authorship and ownership verification systems are illustrated in FIGS. 6 and 7. FIG. 6 illustrates a process for verification with regard to smart contracts and FIG. 7 illustrates a process for verification with regard to a website.

Turning to FIG. 6, a flowchart outlining a method of determining ownership verification of smart contracts is shown. Initially, a creator uploads their source code (or creative work submission) (600). The system may then convert the uploaded source code into bytecode (602). As the system is converting the source code to bytecode, the creator may upload an ethereum address (604). The upload of the ethereum address causes the system to initiate an ethereum block explorer (606). The system then looks up the bytecode at the ethereum address (608) and compares this bytecode to the one that is generated by the uploaded source code (610).

The system then determines if the two bytecodes match (612). If the two bytecodes do not match, the system determines that there is an error and request clarification from the user/creator (614). If the two bytecodes match, the system then searches other existing source code databases (616) to determine if the existing source code has been previously saved or stored. If the uploaded source code is found, the system checks to see if the uploaded source code and the found existing source code is by the same author, or programmer (618). If the found existing source is found under another author, the system determines an error has occurred and requests clarification form the creator (620). If the found existing source code and the uploaded source code has the same author, the system determines that the creator is the true owner or creator of the creative work (622).

Turning to FIG. 7, a flowchart outlining a method of ownership verification of websites is shown. Initially, the system generates a random string for the creator (700). The creator may then post, or input the string as a text entry on a DSN server (702). The system may then initial a DNS record lookup (704). The system then determines if the text has been identified (706). If the text is not identified, the system generates an error message and requests clarification form the creator (708). If the text is identified, the system determines that the user is the owner of the website.

Table 1 provides a description of three embodiments of the extent of validation analysis, including, but not limited to, the review of work process documents, sworn affidavits, copyright assignments, work for hire agreements, invoices, correspondence or any other documents that help prove the authorship and ownership of the creative work. In one embodiment, the system aims to validate the authorship, ownership and originality of the creative work on the balance of probabilities (50%+1) and then generates a Package of Proof. Table 1 provides an example of various levels of analysis that may be documented in the Package of Proof.

TABLE 1

| | | | External validation - evidence that |
|---|---|---|---|
| | Primary proof - evidence | Secondary proof - evidence | strengthens the conclusions that |
| | that originates from the author | that originates from the work | flow from primary & secondary proof |
| Good | click-wrap acknowledgment | file metadata | copyright registry searches |
| | and warranty | | (national registries, WIPO |
| | witnessed statement | | proof) |
| Better | sworn affidavit | authorship information | subject-matter registry sources |
| | | published along with the work | (ISBN, Amazon, Github, |
| | | (i.e. books/periodicals/articles) | Library of congress, SOCAN/ASCAP) |
| | | work process documents (drafts, | online duplicates searches |
| | | sketches, etc.) | images: Google reverse |
| | | | image search, |
| | | | Instagram/Facebook |
| | | | search tool (to be |
| | | | developed), flickr |
| | | | sound recordings: shazam, |
| | | | audium, proprietary tool |
| | | | text: grammarly, easyBib, |
| | | | proprietary tool |
| | | | compilations: combination |
| | | | of the above |
| Best | viva voce testimony (recorded | notarized documentary evidence | subject-matter expert review |
| | interview under oath) | (i.e. certificate of authenticity) | and affidavit |
| | | sworn eyewitness testimony | |

In some embodiments, each validator may undergo screening and training prior to being certified for selection by the system. After certification, these validators may be eligible to receive payment, such as in the form of cryptocurrency tokens, as a reward or payment. These tokens can be locked as a security deposit such that when the validator reaches a threshold of tasks, such as completing a pre-determined number of validations, achieves a predetermined validator score, or the like, the security deposit may then be unlocked. If the security deposit is withdrawn prior to the threshold being reached or depending on other factors, the validator may lose their status as a certified validator.

At the end of training, the candidate will be tested and upon successful completion of the test, will be designated a certified validator. This may be for any validation or validators may be certified for a specific type of creative work. Upon being certified, a security deposit, such as in cryptocurrency tokens, can be awarded and locked in the user's account. This security deposit can be confiscated if the validator is deemed to have acted in a manner which violates a code of conduct

For token, or payment, distribution, validators may execute, in person, or electronically, an agreement for their services. As compensation for their work, the validators may be paid with ERC-20 tokens. The system or system management can calculate or determine a total target compensation for each type of validation work. This compensation amount may then be converted to the ERC-20 tokens based on a prevailing price. In the specific example outlined above, with a team of 10 (one lead plus nine supporting) validators, the bounty may be split as follows: 40%: Lead Validator; 40%: Supporting Validators; 10%: Voters and 10%: Reviewer. However, other breakdowns may be formulated either in predetermined or real-time fashion.

In this specific example, the lead validator automatically earns 40% of the bounty upon approval by the reviewer. Supporting validators split 40% of the bounty based on work performed which may or may not include some of the validation tasks. As supporting validators submit their work/comments, the lead validator can mark it as helpful. Once marked, other supporting validators can upvote or downvote that item. Once a reviewer approves a validation, 30% of the total bounty is split equally between all confirmed useful contributions and 10% is split between all up/down votes on the contributions. Each vote to confirm the validation is awarded 1% of the total bounty with the lead validator getting the first vote.

In some cases, all validations may be reviewed by the system or by system administrators. The 10% allocated to this function can be pooled and rewarded to validators as determined by, for example, specific personnel. As noted, all % allocations mentioned in this section can be configurable.

In further embodiments, the value of the ERC token may be manually set on predetermined regular basis, such as daily. In other embodiments, the system may programmatically retrieve the market price of ERC tokens to set the number of ERC tokens to be earned per validation in real-time. In this embodiment, each validation item may have a bounty (in ERC tokens) associated with the work to be done. This can vary by validation type (e.g. music vs photographs) and/or service level (e.g. regular or expedited). The bounty could also vary over time—early validators may be incentivized by high bounties. With respect to validator payment, the cryptocurrency, or tokens, can be held/used as a bounty and the creator's submission will enter the validation queue and then payments for validators can be executed using, for example, a smart contract to Validators' connected wallets.

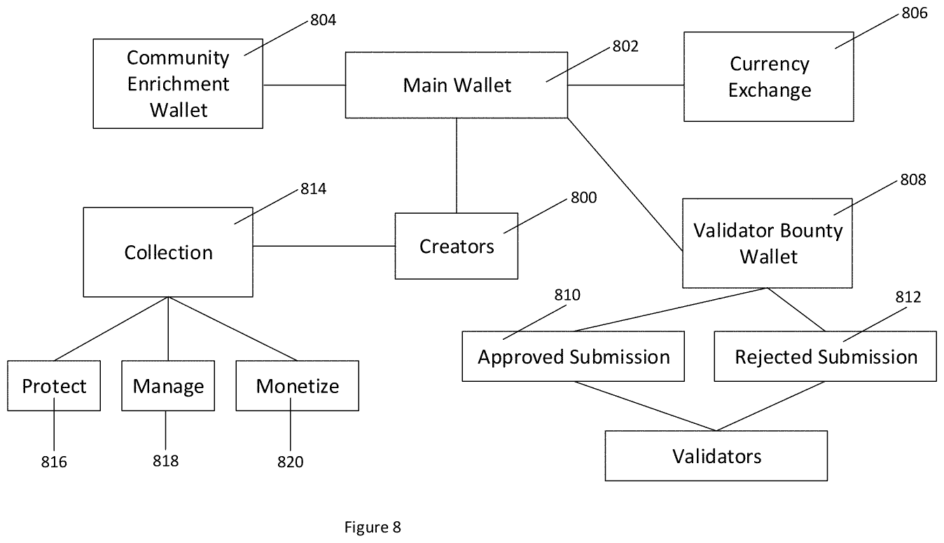

FIG. 8 illustrates a schematic diagram of an embodiment of token handling for a creation/validation process. Initially, creators 800 provide payment, such as fiat payment, to a main wallet 802 or system account. This payment may be for the work that is done by the system to validate a submission and to create the package of proof if the submission is validated. The main wallet may then transfer some of the payment to a community enrichment wallet 804. The system may also use some of the payment to purchase tokens in a currency exchange 806. These tokens may then be stored in the community enrichment wallet 804. Embodiments of the system and method can have a decentralized voting system that will allow tokenholders to vote on how to allocate the tokens in the community enrichment wallet, like payout tokens to wallet holders, create staking campaigns, or re-invest in the system in other ways. This may provide advantages such as, but not limited to, 1) to do social good by protecting and promoting creativity and 2) to enrich a global base of creators, validators, protectors and/or token holders.

Some of the currency within the main wallet 804 may be placed within a validator bounty wallet 808 that may be used to pay the validators for their work based on an approved submission 810 or a rejected submission 812. Payment to the validators may be in the form of bounty payout tokens. Upon approval of a submission, the system may generate a new NFT that is transmitted to the creator. This NFT may then be placed within a collection 814, such as a premium protection collection, that may protect 816, manage 818 and/or monetize 820 the NFT.

In some embodiments, validators may have a predetermined time period to complete the validation. Once the validation work is completed and submitted by the validator, the community (such as other validators) can approve or reject the validator's work through a consensus mechanism. In some cases, all certified and activated validators can vote to agree/disagree with the validator's recommendation. Once the recommendation is approved, the lead validator gets the bounty of cryptocurrency or tokens, and the supporting validators who voted will receive a smaller bounty, or percentage of the bounty. Validations rejected by the community will be reviewed by the system or system managers and the validator or creator may be penalized.

In some embodiments, such as for the embodiments of FIG. 2a or 2b, the system may provide or host a web page for the creative work being validated and, once a validation is initiated and approved, the web page may be updated to include a pair of tabs. A first tab may be for the lead validator to interact with the creator and a second tab may allow the lead validator to interact with supporting validators. This second tab may be used as a voting tab when the lead validator casts a vote to mark it as complete. At that point, the validation work will be read only and will have voting options for the supporting validators. Once the supporting validators have voted and approved the submission, the second tab may be used by the reviewer as the final step before distributing the cryptocurrency as payment to the validators. Both of these tabs may show the validation steps and track the interactions inline. Both tabs may also allow any participant to anonymously report the process for review by a system admin. If such a report is submitted, the validation may in an admin panel queue where an administrator can inspect and interject with comments/feedback and/or take specific action as required.

In some cases, the system may provide validators with a dashboard so that they are able to filter a specific creative work type (e.g. music) for which they are trained and certified or for all types of creative works for which they are trained and certified to validate.

In one example, the dashboard may include a My Queue tab that lists all validation processes which the validator is leading, supporting or reviewing. The dashboard may further include an Opportunities tab that lists all validation items still seeking a lead or supporting validator. These items may be easily identifiable as a leading or supporting opportunity. For supporting opportunities, the user may see the number of spots left to be a validator for the specific opportunity. Users can select and claim items in this list. In some cases, a user should not be able to simultaneously lead more than one validation per creative work type for which they are certified. The dashboard may also include a votes tab that may list all validation items which still require supporting votes. For example, a submission may be in this list if one or more supporting validators have not cast their vote within 24 hours of the lead validator's vote. Once a validator votes via this tab, the validator would be entitled to a predetermined percentage of the vote's bounty allocation. The dashboard may also include a review tab that may show validation items which have successfully passed the required number of votes to be approved. The reviewer should be able to inspect the entire validation process and click to approve or reject. Approved validations result in the bounty being distributed and the validation formally completed. Rejected validations should appear in a queue for a system admin to verify and take next steps on.

As an example, upon successful completion of a validation, a validator may be awarded 100 UV points based on the number of tokens awarded for the validation. For example, if a total of 50 tokens were awarded, each token earned would bump the user's UV score by 2 points. Each validator may have the following tracked and displayed on their profile:
UV Score
#Validations Led
#Validations Supported
#Validations Reviewed

In some embodiments, upon successful completion of one validation in the type for which the validator is certified, the validator can may choose to unlock and claim the security deposit tokens in their wallet. The system may determine that if the user claims the security deposit tokens, they may relinquish their certified status and can no longer perform validations for that type of creative work. In this way, a security deposit can be required to perform duties as a validator.

In some embodiments, the system may include an admin panel for addressing scenarios when problems arise with the validation process. The admin panel may allow the system or a system administrator to step in and take appropriate action. The panel can be set to be visible only to those users with the admin credentials and can show all active validations with an option to filter by creative work type or by validation ID or the like. There can be a priority list for anonymously reported validations. In this panel, once a validation is selected, the system or a system administrator may take, for example, the following actions:
Insert a comment into the Validation work stream at a specified point
Remove comments and/or work items
Reset a helpful work item status so that up/down votes are reset and the Lead will have to tag it as helpful to initiate new up/down votes
Undo the voting so that the Validation work is available to be resumed
Select one or more Validators to be penalized and removed from the Validation

Penalties that a validator may experience can include the following:
a) Revoke the user's Validation status and reclaim their security deposit;
b) Reduce their UV score by a specified % or number of points;
c) If a lead validator is penalized, a message is posted in the validation work stream that allows the remaining supporting validators to claim the lead spot;
d) If a supporting validator does not claim the lead spot within a predetermined time frame, the validation will be posted in the service queue for a new lead validator with the remaining supporting Validators still be assigned to the validation;
e) If supporting validators are penalized, the work resumes but the validation item will appear in the service queue for additional supporting validators to join;
f) Override a reviewer and mark a validation as approved and completed; and/or
g) Reset the validation (remove all assigned validators and previous work items) and repost it in the service queue.

In some cases, notifications may be posted to validator accounts.

FIG. 10 is a flowchart outlining a method of decentralized protection of intellectual property. In some embodiments, after a creative work or submission is validated or approved, such as disclosed with respect to FIG. 2a, 2b or 11, the contents of the submission may be protected by protectors using the system of the disclosure. Similar to validators, protectors may be seen as a distributed group of users who work to identify infringement of the creative content of the validated submission. Protectors may work in a gig-like fashion. Once a protector finds unauthorized use of creative content, the protector may submit this information to the system and the system then notifies the creator of the unauthorized use. The creator can then send a demand letter or otherwise contact the infringing party directly or via the system. These letter(s) may contain a payment link for an amount specified by the creator to remedy the situation. Protectors will be certified and activated through a similar on-boarding process as validators. Protectors will earn cryptocurrency for their work. Protectors may work on an ad-hoc or scheduled basis depending on the desire of the creator or the settings of the system or the like.

In one embodiment, in order to initiate the method of decentralized protection of intellectual property, the system may receive a request, such as an electronic request, from a creator to monitor for unauthorized use of the creative work (1000). Alternatively, the system may automatically perform this monitoring once a submission has been approved and validated. The system then engages at least one protector (1002). A protector may be seen as an individual who performs the tasks to determine if there is any unauthorized use of the creative work. After determining or engaging with at least one protector, the system provides the package of proof relating to the validated submission to the at least one protector (1004). The protector may then initiate the search for unauthorized use (1006). In one embodiment, the protector may use internal and/or 3^{rd} party plagiarism detection engines (1008). This is discussed above with respect to FIG. 5. If the protector determines that there is unauthorized use (1010), the protector may upload the evidence of authorized use to the system (1012) where it is stored by the system. The system may then generate a report documenting the unauthorized use and the information that was found by the protector (1014). This is then reported by the system to the creator (1016). If the protector determines that there is no unauthorized use (1018), the protector may upload a list of the database that were searched (1020) which is then stored by the system. The system may then generate a report documenting the database searched by the protector (1022). The system may then generate and provide a report to the creator (1016).

With respect to the timestamping of intellectual property component 104 of FIG. 1 or 12a, the timestamping of intellectual property component 104 includes a system that utilizes blockchain technology to record a hash record of the intellectual property and other relevant data on the blockchain. This hash on the blockchain provides an immutable, public record of the user's intellectual property. In one embodiment, the disclosure provides different systems and methods to complete this: 1) batch timestamping system and method component 118 and 2) individual staking claims system and method component 122, each of which has its own benefits and levels of protection of the intellectual property. This disclosure also includes a tool that enables the user to verify and prove that their intellectual property was hashed on the blockchain. This provides the user with an ability to prove their hashed record in cases of future intellectual property infringement or dispute. This functionality may be provided by the hash verifier tool component 120.

With batch timestamping (component 118), the intellectual property (e.g. artwork, music, literary work) will be hashed to the blockchain with a group of other pieces of intellectual property, rather than an individual hash for each piece of intellectual property. By recording their date, name and intellectual property on the blockchain, users will have an immutable and public record of their intellectual property.

In one embodiment of batch timestamping component 118, the batch timestamping may be performed as follows, but not necessarily in this order:

i) the user uploads their intellectual property and relevant information to the system which is received by the system (similar to the creator initiating a submission);

ii) the system sends the intellectual property and relevant information to a hashing function module, or component, that can perform a hashing function to generate a hash of the intellectual property (H1). The hashing function module may be seen as a cryptographically secure hashing function that is secure and publicly available on the blockchain to provide the ability to prove a record on the blockchain if the centralized entity who facilitated the batch timestamp ceases to exist;

iii) concurrently, the system generates a random string of text, which may be referred to as a secret string, S via a random string generator module to provide security to the user. Without it, anyone may be able to claim the timestamp;

iv) secret string, S, and the hash (H1) are then sent to the hashing function module to generate a new hash of the intellectual property and the secret string which may be seen as H2;

v) unique hash and secret string combinations (H2) for all users in the batch timestamping are then generated by the system;

vi) the list of H2 hashes are stored in a master file by the system; and

vii) the master file is then hashed (which may be seen as a master file hash (H3)) and written to the blockchain by the system.

By staking a claim individually (using individual stake component 122), rather than through the batch timestamp process, creators have more protection for their creative work. Individual stakes claims may provide advantages to the creators. Firstly, through individual stake, or staking claims, the user, or creator, has their own dedicated hash on the blockchain. Secondly, individual staking claims allows users to create a record on the blockchain, that can reference important information like authorship details, artist residency, employment information and date of creation and the like. These are pieces of evidence that legacy copyright agencies typically collect for copyright registration. Similar evidence may be beneficial for other types of intellectual property. Thirdly, the individual stakes claim component provides creators with the ability to attach a single hashed version of supporting documents to the record on the blockchain. Supporting documents include any evidence generated by the creator that helps prove that they are the author and/or owner of the work. Some examples include photos of the creator in the act of creating the work, previous sketches and versions, and ownership assignment documents. Legacy copyright agencies do not provide ability for a user or creator to upload and store documents that help prove they are the author, thereby reducing the effectiveness of the copyright protection. By writing these supporting documents to the hash on the blockchain, the creator is provided an additional level of proof that the creator can reference in the future.

In one embodiment of individual staking claims component 122, the individual stakes claim may be performed as follows:

i) the user uploads their intellectual property, or creative work, to the system which is received by the system. The user also uploads additional information pertinent to the protection of that intellectual property, including supporting documents which are also received by the platform, or system;

ii) the system then sends the intellectual property, or creative work; the additional information (AI), and the supporting documents (SD) to a hashing function, such as the hashing function module. In one embodiment, the hashing function module may be seen as a cryptographically secure hashing function that is secure and open sourced to provide the ability to prove a record on the blockchain if the centralized entity who facilitated the individual staking claims ceases to exist; and

iii) the hashing function module writes the IP, AI, and SD to the blockchain.

In one embodiment of hash verification with respect to batch timestamping, the system provides the functionality as follows:

i) the user inputs the secret string, the piece of intellectual property (or creative work) and the master file into the hash verifier tool 120 where the input is received, and possibly stored, by the tool;

ii) the system, such as via the tool 120, sends the secret string and piece of intellectual property to the hashing function module which generates a hash. (This produces the same hash referenced as H2 above);

iii) the tool then uses that hash (generated by the hashing function module) to search the master file. This may be performed by comparing the hash with previously stored hashes. If the hash is not found in the master file, the tool returns no results and this indicates that the intellectual property is not found in the record specified by the user. If the hash is found, this provides confirmation that the intellectual property was hashed and written to the master file;

iv) the master file is then sent to the hashing function module which generates a hash of the master file. If successful, the generated hash will equal the hash referenced above as H3; and

v) the tool then queries a smart contract to determine if the hash of the master file is found. If it is not found, the master file is not found on the blockchain. If it is found, the tool will output a record of the results found on the blockchain.

In one embodiment of hash verification with respect to individual staking claims, the system may provide the functionality as follows:

i) the user uploads a file, such as a ZIP file, that contains the piece of intellectual property, additional information, and supporting documents to the system, which is received by the system;

ii) the system sends the ZIP file to the hashing function, or hashing function module, and a hash of the ZIP file is generated; and

iii) the tool then queries a smart contract to determine if the hash of the ZIP file is found. If it is not found, the master file is not found on the blockchain. If it is found, the tool will output a record of the results found on the blockchain.

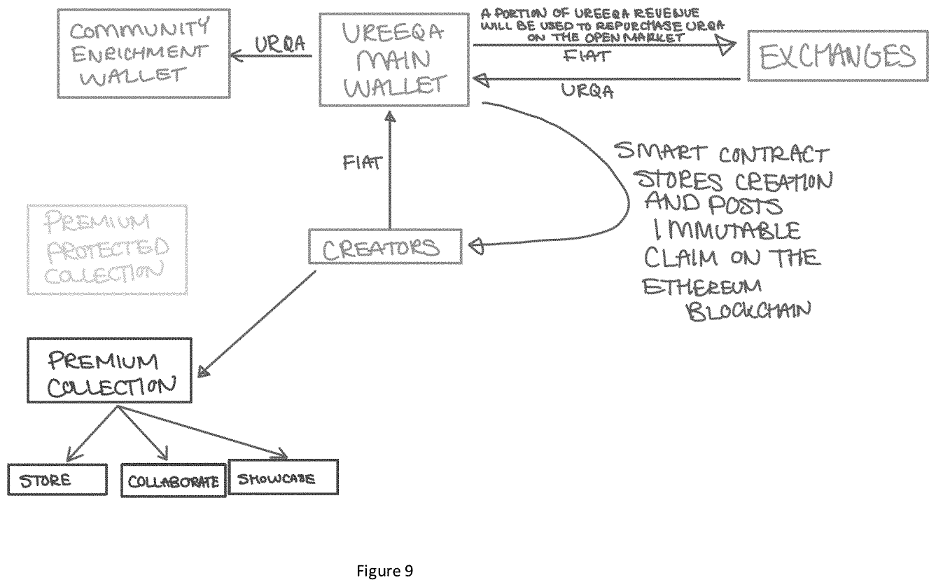

FIG. 9 illustrates a flowchart of an embodiment of payment for timestamping.

With respect to the tokenization component 106 of FIG. 1 or 12, the enforceable and divisible tokenization of IP component 106 leverages the strengths of blockchain technology while integrating and respecting the legal contracts required to make it enforceable.

In one embodiment of the tokenization component 106, the component enables the ownership and management of creative work, such as one protected by copyright, to be split into two sets of non-fungible tokens (NFTs): 1) validated NFTs and 2) child NFTs. In one embodiment, the component 106 provides legal documents to be included in the solution to provide enforceability to the application in cases or jurisdictions that do not respect this implementation. The legal documents can define IP ownership rights, voting mechanisms and instructions for handling payments. In other embodiments of the system, the legal contract/document may include terms and rules beyond ownership, voting and payment. In order to incorporate the legal document(s) into the NFTs, blockchain technology such as hashing functions can be used.

A validated NFT, which may be generated by component 126, may be seen as an NFT that has creative work that has been validated as authentic and/or true, as determined through validation determination component 112. For validated NFTs, details are stored (e.g. as components of the NFT or externally and linked by reference data stored in the NFT) about the creative work, including supporting documents, and other details about the creative work, the creator, and the current owner(s) of the IP in the work, including information collected in validation component 102. In an embodiment, author details are stored in the NFT, a hash of the supporting documents is stored in the NFT and a reference link to externally stored documents/information is stored in the NFT. To allow for multiple ownership of IP in a single item of creative work, the component 106 may utilize a NFT standard that allows for the batch creation of fungible tokens for the NFT that act as a proxy for shares or rights to ownership and revenue streams. This also enables the transfer of ownership of the IP. As noted above, to enable the enforceability of the ownership of IP through NFTs, legal contracts/documents can be included in the NFT's record on the blockchain.

Once a validated NFT is minted for IP owners of a creative work, one or more child NFTs can be minted. These child NFTs can be minted and used to provide rights to owners of the validated NFTs or third parties, including, but not limited to:
i. Collectible versions of the creative work;
ii. Certificate of authenticity for the creative work;
iii. Contractual right to print;
iv. Contractual right to publish;
v. Contractual right to perform;
vi. Contractual right to film;
vii. Contractual right to record; or
viii. Multiple contractual rights.

In one embodiment of the disclosure, the child NFTs are linked to the validated NFT using a dual link, where each child NFT stores the connected validated NFT contract address and NFT ID; and that corresponding Validated NFT stores the child NFT's smart contract address the NFT ID. Similar to the method described above for validated NFTs, the legal rights of a child NFT can be specified in a legal contract/document.

In one embodiment, a legal document, or contact may be incorporated into a validated NFT via the following process:

i) the user who wishes to mint a validated NFT that is divisible and enforceable uploads information about their creative work to the system. This information includes the legal contract/document that defines ownership rights, voting rules, payment rules, etc., as discussed above;

ii) the system sends the relevant creation information to the validation process such as disclosed above. Trust mechanisms may also be implemented;

iii) the system also sends the legal contract/document to a hashing function module, or component, that performs a one-way hashing function to generate a hash of the legal contract;

iv) the hash of the legal contract/document is sent to a validated NFT smart contract component along with other information, such as, but not limited to, ID Number, Owners Information (Owner Address, Number of Shares), Creator Names, Creation Date, File to hash, including the original creation file and/or a zip file of the Package of Proof, and/or Payment Plan (Percentage Type and Value to Parties or Fixed Value or Free); and

v) the validated NFT is then minted with the legal contract/document encoded in smart contracts that define the voting and payment rules.

With respect to the encapsulation component 108, the encapsulating trust mechanisms into NFTs component 108 provides functionality where buyers, sellers and corporations have systems and tools to determine that an NFT and its associated creative work is authentic, among other things. The system includes (1) a validated NFTs component 126 (2) a NFT Authenticity Checker component 128 and (3) a NFT Redemption Centre component 130.

In contrast to most NFTs sold on marketplaces today, a validated NFT allows for key information to be stored within the NFT and/or hashed in the NFT record. In one embodiment, a validated NFT may represent ownership of the underlying creative work associated with the NFT (musical works, literary works, visual works, etc.). In one embodiment, the validated NFT may contain details about the creator, the date of the creation, the ownership (fractional or whole) of the creative work, and a hash of supporting documents that support authorship, ownership and originality details. The information stored within the NFT includes the package of proof component 114 and other information generated from validation component 112. Importantly, a validated NFT is only minted when the information provided by the user is validated through validation component 112 described above.

The NFT Authenticity Centre, or component 128, provides the user, whether an NFT buyer, seller, or owner, with a tool to verify the authenticity of an NFT. This tool allows the user to analyze the Authenticity, Copyright and Holder Rights, among other things. The tool provides for the user to be able to verify that the NFT was minted on a smart contract approved by the owner, whether the person who minted the NFT owns the copyright, and what utilities, if any, remain attached to the NFT.

The NFT Redemption Centre component 130 provides the user with the ability to obtain information and manage the utilities associated with an NFT and to redeem all or some of the utilities.

In one embodiment of validated NFT minting:

i) the owner of the creative work uploads the details about the creation, or creative work, and its ownership, and the utilities associated with the desired NFT to the system, which is received by the system;

ii) the system then performs a validation process of the details of the creative work to verify the creative work's authorship, ownership, and originality, among other things such as performed or provided by the validation component 112;

iii) the system then generates a package of proof, which documents the validation process to provide validation of the creative work in order for a validated NFT to be generated. Validation of the work means that the system verifies that the owner is the original creator of the creative work;

iv) the system then sends the package of proof, among other information to a Validated NFT smart contract component. In one embodiment, the other information that is sent to the Validated NFT Smart Contract may include at least one of: ID Number, Owners Information (Owner Address, Number of Shares), Creator Names, Creation Date, File to hash, including the original creation file and/or a zip file of the Package of Proof, and/or Payment Plan (Percentage Type and Value to Parties or Fixed Value or Free);

v) the validated smart contract component, or validated NFT component then mints a new validated NFT. In one embodiment, the validated NFT is minted with a predetermined number, such as X, shares (as ERC 1155s tokens) so that fractional ownership of the NFT may be provided, if desired. The ERC 1155 tokens allow for the tokens to be proxy for shares, thereby making the NFT divisible. The distribution of shares is minted for each owner associated with the validated NFT as listed on the validated NFT smart contract. An owner can sell any amount of their shares of the validated NFT, which would transfer part ownership in the underlying creative work to the buyer. Each validated NFT is created such that its proportional ownership may be represented as shares (E.g. the validated NFT ownerships is represented by 100 shares which represents 100% ownership). The owner of the validated NFT can also sell a portion of their ownership in the NFT through the sale of shares (i.e. owner sells 30 shares in the Validated NFT such that a 3^{rd} party owns 30%);

vi) the system may then generate collectible NFTs based on the Validated NFT. Through Collectible NFTs, copies of the creative work can be sold without transferring the underlying ownership in the creative work. The owner of the validated NFT can mint new collectible NFTs. In one embodiment of the system, the majority of owners of the validated NFT must vote in favour of a proposed transaction before execution. A collectible NFT cannot be minted before a validated NFT is minted however, once a validated NFT is minted, collectible NFTs can be minted at any time;

vii), if at least one collectible NFT is required, to create or generate the collectible NFTs, information associated with the validated NFT and the desired utilities, if any, are sent to the collectible NFT smart contract component or collectible NFT component; and

viii) the system then minds the collectible NFT.

In one embodiment of NFT authenticity checker component 128 operation:

i) a users connects to the system;

ii) the user may either: 1) connect their digital wallet to the system enabling the system to search the wallet for NFTs or 2) enters the NFT's contract address and token ID to search for the NFT which is received by the system that then performs the search;

iiia) If the user connects their wallet:
1) The system scans the wallet for NFTs.
2) If an NFT is found in the wallet, the system looks up the NFT in a database associated with the system.
3) If the NFT is not found, the system will return a response of No Results to the user.
4) If the NFT is found, the system verifies that the NFT has a record on the blockchain and/or within the system. The system may also display the information associated with the NFT which provides proof of the NFT's authenticity, copyright and holder rights, as described above.

iiib) If the user enters the NFT's contract address and token ID:
1) The systems looks up the NFT in the database.
2) If the NFT is not found, the system will return a response of No

Results to the user.
3) If the NFT is found, the system verifies that the NFT has a record on the blockchain and/or within the system. If so, the system displays the information associated with the NFT which provides proof of the NFT's authenticity, copyright and holder rights, as described above.

iv) an output of either No Results or information and associated details that the NFT was found provides the user with valuable information to assess the authenticity of the NFT that they are considering purchasing or obtaining.

For NFT redemption centre component 130, there are two parties which may be seen as the user and the client. The client may be seen as the owner of the validated NFT that minted the collectible NFT and provides the associated utilities. In order to facilitate the redemption of utilities, the client must provide a set of predetermined information before it is able to collect payment from the user who may be seen as a purchaser of the NFT redemption.

One method of NFT redemption may be as follows:

i) after purchasing the collectible NFT, the user is provided access to the system to either view or redeem utilities;

ii) the user logs into the system which enables the system to connect to the user's cryptocurrency wallet;

iii) the system scans the wallet for NFTs. If NFTs are found, the system looks up the NFT in the database. If a match is found in the database, the system will show all utilities associated with the NFT and the status of each utility;

iv) if the user wishes to redeem their utility, the user inputs the information required for redemption into the system which is processed by the system. For example, if a utility is a type of merchandise, the user may input their home address for shipment of the merchandise to their home. In another example, if a utility is a specific number of cryptocurrency tokens, the user may input the wallet address they would like to have the tokens delivered to and the system performs the necessary actions to deliver the tokens;

v) after all the required information is collected from the user by the system, the system notifies the client of the redemption, and the utilities are distributed to the user. This distribution may be done automatically by the system or completed by the client via the system or manually; and

vi) after distribution and confirmation of receipt of the utilities, the system updates the status of the utility in the database, including an update of the metadata associated with the NFT. If the user decides to only redeem a portion of the utilities, the user may resell the collectible NFT to someone else who could then login to the platform and redeem a different utility such as in a manner similar to the process discussed above. Metadata is used to keep track of the redemption status of each utility. The hashed terms on the blockchain proves the terms that were originally conveyed with the NFT sale. In one embodiment, the utility statuses can be updated on the blockchain to keep all proof on chain.

With respect to the monetization component, the monetization component 110 provides the functionality for users to monetize their creative works that are saved as NFTs on the blockchain. Monetization component 110 utilizes blockchain technology, like NFTs, and interacts with the other components of the system 104 to improve existing methods of monetization of creative works and to create new forms of monetization of creative work.

In one embodiment, component 110 includes the NFT marketplace component 134. As noted earlier, existing NFT marketplaces have created a void of trust from the unauthorized and/or fraudulent sale of creative work through NFTs. In one embodiment, NFT marketplace component 134 facilitates transactions of validated NFTs. As noted above, validated NFT component 126 provides important information regarding the copyright of the creative work and enables transparency regarding the authorship and ownership of the creative work and NFT. Validated NFT component 126 also enables the transfer of NFTs that incorporates legal contracts/documents that may be respected be the legal system, whereas the transfer of NFTs is not recognized as a legal transfer of intellectual property rights in all jurisdictions.

In another example, component 110 includes IP collateralization component 136. IP collateralization component 136 enables lending against the tokenized intellectual property or minted NFT. The collateralization of intellectual property through NFTs provides an additional monetization avenue for creators. Collateralization of NFTs today is especially risky because of the lack of transparency with typical NFTs. Validation component 112, package of proof 114, enforceable division of IP component 124 and validated NFT component 126 provide important information that supports the process of collateralization of creative work through NFTs.

In another example, monetization component 110 includes music publishing component 142. Many small musicians today have their music played across the world that is unreported and/or unauthorized. Component 142 includes a process whereby musicians can utilize protector program component 116 to uncover unauthorized and/or unreported use of their musical work and request compensation for the unauthorized use.

For the tokenized tradable rewards embodiment (such as provided by component 139), assuming that an NFT has been validated and minted, it may then be purchased by an individual. In this example, a validated NFT may be seen as an NFT that is associated with a creative work where the creative work has been validated as being authentic i.e. that it is not a forgery or a copy of a creative work that has been created by someone else. Use of validated NFTs provides comfort to a buyer that they are entering a valid purchasing agreement.

After purchasing the NFT, a smart contract associated with the NFT is updated to reflect the purchase by the user. The user may purchase the entire right to the NFT or may purchase a share of the NFT. The updated smart contract is then stored in the database.

Over time, sponsors or retailers may be interested in being associated with the NFT or may provide utilities or rewards to owners of the NFT. These rewards may increase the overall value of the NFT. For instance, if the NFT relates to a football play, the football team that the player plays for may provide a pair of tickets each year to owners of the NFT. Assuming that the pair of tickets have a worth of $500, the value of the NFT will clearly increase due to this reward. All owners of the NFT will then see the worth of the NFT increase whereby if a buy wishes to sell their ownership in the NFT, they may be able to sell it for more than their purchase price due to the new pair of tickets reward. This may be seen as how monetizing the NFT via tradeable rewards is executed.

For the tokenization insurance component, the component 143 may provide the functionality for the issuance of insurance policies on tokenized intellectual property or minted NFTs whereby the issuance of the insurance policy is supported by information generated by other components of the system. In one embodiment, the user will have access to insurance options to insure the creative work purchased through the system. To protect the buyer, the insurance policy provided will be issued to the buyer of the NFT through the system and method of the disclosure. Providing insurance options has several benefits, including: (i) it gives all parties on the platform added confidence that the NFT they are purchasing is authentic, (ii) it gives the owner of the NFT a basis upon which to make a claim under their NFT insurance policy if the NFT is deemed counterfeited, and (iii) it will deter infringers from creating counterfeit NFTs. Insurance providers will only provide insurance options for intellectual property that has been validated by the system.

A validated NFT can be minted for the source creative work (e.g. image or video clip) and collectible NFTs can be minted that reference the master. With collectible NFTs backed by a validated NFT, a new NFT can be purchased representing an insurance policy on the collectible NFT. If the NFT is deemed to be in violation of the creator's rights, the NFTs (collectible and insurance) can be deposited into a smart contract and a decentralized group of validators can be incentivized to perform the work to ascertain the unauthorized use claim. If there is a payout to be made, the insurance company can be provided with the proof for payout or if on-chain, the insurance NFT can be sent to a smart contract with the payout amount. The insurance NFT can be burned and the smart contract can pay the claim out.

The above paragraphs are provided as a few examples and do not encompass all of the embodiments of monetization component 110. Monetization component 110 may provide a plurality of different options for a creator to select and then guides the creator through the process necessary to monetize the creative work in the selected manner.

In other embodiments, creative content that is posted/uploaded in the system, through timestamping component 104 or validation component 102 or monetization component 110 may have unique profile pages possibly with creators having their own pages to display their creative works. These profile pages may enable users or creators to showcase their creative work, tell the world what inspired the creation, and allow other users to like, comment and direct message to collaborate.

Embodiments of the system and method herein can make use of a specially designed token, which is a digital asset for the ecosystem. In some embodiments, the specially designed token is an ERC20 compatible token on, for example, the Ethereum blockchain. The system's NFTs, as discussed above, may be implemented as ERC721 tokens or ERC1155 tokens. Ethereum deployment may be selected based on Ethereum's broad adoption by investors and community stakeholders. The compatibility with the ERC20 token leverages Ethereum's development tools, wide wallet and exchange adoption, and developer expertise. However, it will be understood that embodiments of the system and method may operate on a different blockchain or provide interoperability with other blockchains.

The tokenization of embodiments of the system and method is intended to allow users and tokenholders to not only benefit from rewards within the community but also participate in the growth of the system and method and ecosystem generally. The demand for the specially designed token can be expected to grow in-line with platform adoption leading to a token economy where all stakeholders may benefit.

Embodiments of the system and method herein may be useful for new business models and structures such as, for example, Decentralized Autonomous Organizations (DAOs) and creators within the crypto space as they stake their claim to things like websites, source code and whitepapers. For example, the legal status of DAOs remains unclear as blockchain-based technologies have evolved faster than applicable legal frameworks. With traditional corporate entities, the entity typically holds the intellectual property. Because it is not certain whether DAOs are legal entities, it is not clear how to hold creative content like websites, source code and whitepapers through traditional means. This example demonstrates the need for the ability to stake a claim through non-traditional means and tokenize the claim to that creative content. For example, with embodiments herein, this process could involve the DAO initially staking the claim to their creative content on the system. After validation, an NFT would be generated which would be owned by the DAO and can be stored in the DAO's publicized wallet.

In some embodiments, a portion of revenue generated by the system may be used to repurchase the specially designed tokens on the open market. These purchased tokens may be transferred to a community enrichment wallet. The community enrichment wallet provides tokenholders with a say in the overall ecosystem. In some cases, the system may have a decentralized voting system that leverages cryptography to allow tokenholders to vote on what to do with tokens in the community enrichment wallet. For example, the community can opt to payout tokens to wallet holders, create special campaigns (staking rewards, validator/protector bonuses), or re-invest in the overall ecosystem in other ways.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only. Alterations, modifications and variations can be effected to the particular embodiments by those of skill in the art without departing from the scope, which is defined solely by the claim appended hereto.

What is claimed is:

1. A system for creative works management comprising:
a decentralized validation of intellectual property (IP) component, executing on a processor, for validating an electronic submission of a creative work from a user, the validation based on input from a set of validators and a proof of validation stored to a blockchain;
a decentralized timestamping of intellectual property component, executing on the processor that is in communication with the blockchain, for storing the electronic submission on the blockchain and for generating a hash code associated with the electronic submission for storage on the blockchain;
an enforceable and divisible tokenization of intellectual property component, executing on the processor, for minting a non-fungible token (NFT) of the creative work to generate a validated NFT of the creative work on the blockchain;
an encapsulating trust mechanisms into NFT component, executing on the processor, for combining validation of the electronic submission with the validated NFT and for storing the combination on the blockchain; and
a monetization component, executing on the processor and in electronic communication with the user and the blockchain, for assisting the user in monetizing the validated NFT.

2. The system of claim 1 wherein the decentralized validation of intellectual property (IP) component comprises:
a validation determination component for determining authenticity or originality of the creative work; and
a package of proof component for generating a package of proof including process taken to determine authenticity or originality of the creative work.

3. The system of claim 2 wherein the decentralized validation of IP component further comprises:
a protection program component for determining if there is unauthorized use of the creative work.

4. The system of claim 1 wherein the decentralized timestamping of intellectual property component comprises:
a batch timestamping component for storing the electronic submission in a batch manner on the blockchain;
an individual stake claims component for storing the electronic submission in an individual manner on the blockchain; and
a stake claims hash verifier component for confirming the electronic submission is stored on the blockchain.

5. The system of claim 1 wherein the enforceable and divisible tokenization of intellectual property component comprises:
a tokenization of IP component.

6. The system of claim 1 wherein the encapsulating trust mechanisms into NFTs component comprises:
a validated NFT component for minting the validated NFT;
a NFT authenticity checker component for determining an authenticity of the validated NFT; and
a NFT redemption centre component.

7. The system of claim 1 wherein the monetization component comprises:
a NFT marketplace component for displaying a list of validated NFTs; and
a set of monetization pathways components for assisting the user in monetizing the validated NFT.

8. The system of claim 7 wherein the set of monetization pathways components comprises at least one of a tradeable NFT rewards program component; an IP collateralization component; a licensing component; a fractional ownership component; a music publishing component; a transfer of ownership component and a tokenized insurance component.

9. A method of creative works management comprising:
receiving, from a user, an electronic submission, the electronic submission including a creative work and supporting information associated with creation of the creative work;
storing the electronic submission on a blockchain and timestamping the submission;
validating if the creative work associated with the electronic submission is original; and
generating a package of proof if the electronic submission is validated.

10. The method of claim 9 further comprising:
minting a validated non-fungible token (NFT), the validated NFT including at least the creative work and the package of proof.

11. The method of claim 10 further comprising:
minting a child NFT associated with the validated NFT.

12. The method of claim 10 further comprising:
minting a collectible NFT associated with the validated NFT.

13. The method of claim 12 further comprising:
monetizing the validated NFT or the collectible NFT via a monetization process.

14. The method of claim 12 wherein monetizing the validated NFT comprises at least one of:
monetizing via a tradeable NFT rewards program component; monetizing via an IP collateralization component; monetizing via a licensing component; monetizing via a fractional ownership component; monetizing via a music publishing component; monetizing via a transfer of ownership component; or monetizing via a tokenized insurance component.

15. The method of claim 10 wherein storing the electronic submission on a blockchain and timestamping the submission comprises:
storing the electronic submission in a batch manner.

16. The method of claim 10 wherein storing the electronic submission on a blockchain and timestamping the submission comprises:
storing the electronic submission in an individual manner.
